(19) United States
(12) Patent Application Publication
(10) Pub. No.: US 2011/0268405 A1
(43) Pub. Date: Nov. 3, 2011

(54) STACKABLE SHELVES FOR A FIBER OPTIC HOUSING, AND RELATED COMPONENTS AND METHODS

(76) Inventors: Monique L. Cote, Fort Worth, TX (US); Brent M. Frazier, Haslet, TX (US); Raymond G. Jay, Mansfield, TX (US); Brian D. Kingsbury, Watauga, TX (US); Michael Heath Rasmussen, Keller, TX (US)

(21) Appl. No.: 12/940,699

(22) Filed: Nov. 5, 2010

Related U.S. Application Data
(60) Provisional application No. 61/329,948, filed on Apr. 30, 2010.
(60) Provisional application No. 61/329,925, filed on Apr. 30, 2010.
(60) Provisional application No. 61/329,898, filed on Apr. 30, 2010.
(60) Provisional application No. 61/332,572, filed on May 7, 2010.
(60) Provisional application No. 61/332,548, filed on May 7, 2010.
(60) Provisional application No. 61/332,529, filed on May 7, 2010.
(60) Provisional application No. 61/332,508, filed on May 7, 2010.

(51) Int. Cl. G02B 6/46

(52) U.S. Cl. 385/135

(57) ABSTRACT

Stackable shelves for a fiber optic housing and related components and methods are disclosed. In one embodiment, a stackable shelf for a fiber optic housing is provided. The stackable shelf comprises a mounting surface and one or more stacker assemblies stacked above the mounting surface, each configured to support fiber optic equipment in one or more height spaces. The one or more stacker assemblies are further configured to support one or more additional removable stacker assemblies each configured to support fiber optic equipment at one or more additional height spaces. In another embodiment, a removable stacker assembly configured to support fiber optic equipment in a stackable shelf is provided. Related methods are also disclosed.

### RELATED APPLICATIONS

The present application claims priority to U.S. Provisional Patent Application Ser. No. 61/329,948, filed Apr. 30, 2010, entitled “Stackable Shelf For A Fiber Optic Housing,” the disclosure of which is relied upon and incorporated herein by reference in its entirety.

The present application is related to U.S. Provisional Patent Application Ser. No. 61/329,925, filed Apr. 30, 2010, entitled “Fiber Optic Housing Adapted to Accommodate Both Modules and Panels,” the disclosure of which is relied upon and incorporated herein by reference in its entirety.

The present application is also related to U.S. patent application Ser. No. ______, filed ______, 2010, entitled “Fiber Optic Housings Configured To Accommodate Fiber Optic Modules/Cassettes and Fiber Optic Panels, And Related Components and Methods,” the disclosure of which is relied upon and incorporated herein by reference in its entirety.

The present application is also related to U.S. Provisional Patent Application Ser. No. 61/329,898, filed Apr. 30, 2010, entitled “Rotatable Routing Guide Assembly,” the disclosure of which is relied upon and incorporated herein by reference in its entirety.

The present application is also related to U.S. Provisional Patent Application Ser. No. 61/332,572, filed May 7, 2010, entitled “Fiber Optic Housing,” the disclosure of which is relied upon and incorporated herein by reference in its entirety.

The present application is also related to U.S. Provisional Patent Application Ser. No. 61/332,548, filed May 7, 2010, entitled “Attachment Housing For A Fiber Optic Housing,” the disclosure of which is relied upon and incorporated herein by reference in its entirety.

The present application is also related to U.S. Provisional Patent Application Ser. No. 61/332,529, filed May 7, 2010, entitled “Fiber Optic Management Area In A Fiber Optic Housing,” the disclosure of which is relied upon and incorporated herein by reference in its entirety.

The present application is also related to U.S. Provisional Patent Application Serial No. 61/332,508, filed May 7, 2010, entitled “Grommet and Routing Clip Assembly,” the disclosure of which is relied upon and incorporated herein by reference in its entirety.

The present application is also related to U.S. Provisional Patent Application Ser. No. 61/180,331, filed May 21, 2009, entitled “Fiber Optic Equipment Guides and Rails Configured With Stopping Position(s), and Related Equipment,” the disclosure of which is relied upon and incorporated herein by reference in its entirety.

The present application is also related to U.S. patent application Ser. No. 12/576,806, filed Oct. 9, 2009, entitled “Fiber Optic Equipment Guides and Rails Configured With Stopping Position(s), and Related Equipment and Methods,” the disclosure of which is relied upon and incorporated herein by reference in its entirety.

### BACKGROUND

1. Field of the Disclosure

The technology of the disclosure relates to fiber optic hardware, and more particularly to fiber optic housings suitable for supporting fiber optic equipment, including fiber optic modules/cassettes and fiber optic panels.

2. Technical Background

Benefits of optical fiber include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection points linking optical fibers to provide “live fiber” from one connection point to another connection point. In this regard, fiber optic equipment is located in data distribution centers or central offices to support interconnections.

The fiber optic equipment is customized based on the application need. The fiber optic equipment is typically included in housings designed to support the fiber optic equipment, which are mounted in equipment racks to optimize use of space. One example of such fiber optic equipment is a fiber optic module. A fiber optic module is designed to provide cable-to-cable fiber optic connections and manage the polarity of fiber optic cable connections. A fiber optic module is mounted to a chassis or housing that is specifically designed to support fiber optic modules/cassettes. Another example of such fiber optic equipment is a fiber optic panel (also referred to as a “patch panel”). A fiber optic panel is designed to provide connection or termination points for optical fiber. A fiber optic panel typically includes fiber optic adapters that are configured to receive fiber optic connectors connected to the optical fiber to be connected or terminated. A fiber optic panel is typically mounted to a chassis or housing that is specifically designed to support fiber optic panels.

The size of the fiber optic housing to support the desired fiber optic equipment may vary or change from application to application. For example, it may be desired to provide a fiber optic housing of 1 U size to support fiber optic equipment, such as modules, cassettes, and panels in a 1 U height space (a “U” size is equal to approximately 1.75 inches of height in an equipment rack). If additional fiber optic equipment is needed to provide greater connection capacity, fiber optic housings of greater U size may be provided. For example, a fiber optic housing may be provided of 2 U, 3 U, or 4 U height size to support additional fiber optic equipment in the same fiber optic housing. However, each size variation in fiber optic housings requires producing and/or maintaining inventory for different component or part variations for the various fiber optic housing sizes available, and incurring related additional costs. Further, if the desired fiber optic housing size is not available during an installation or reconfiguration, delays in the installation or reconfiguration may result.

### SUMMARY OF THE DETAILED DESCRIPTION

Embodiments disclosed in the detailed description include stackable shelves for a fiber optic housing and related components and methods. In one embodiment, a stackable shelf for a fiber optic housing is provided. The stackable shelf comprises a mounting surface. The stackable shelf also comprises one or more stacker assemblies stacked above the mounting surface, each configured to support fiber optic equipment in one or more height spaces. The one or more stacker assemblies are further configured to support one or more additional removable stacker assemblies each configured to support fiber optic equipment at one or more additional height spaces.

In another embodiment, a stackable shelf for a fiber optic housing is provided. The stackable shelf comprises a mounting surface, a combination of one or more front stacker assemblies, and/or a combination of one or more rear stacker assemblies. The mounting surface is movably attached to the fiber optic housing. The combination of one or more front stacker assemblies and the combination of one or more rear stacker assemblies removably attach to the stackable shelf to allow the stackable shelf to be configured in one of a U size (e.g., 1 U, 2 U, 3 U, or any U, or fractional Us) shelf within the fiber optic housing.

In another embodiment, a method for installing fiber optic equipment in a stackable shelf is provided. The method comprises providing a mounting surface. The method also comprises stacking one or more stacker assemblies above the mounting surface, each of the one or more stacker assemblies configured to support fiber optic equipment in one or more height spaces. The method also comprises installing fiber optic equipment supported by the one more stacker assemblies about the mounting surface.

In another embodiment, a removable stacker assembly configured to support fiber optic equipment in a stackable shelf is provided. The removable stacker assembly comprises a support member. The support member comprises a support body. The support member also comprises at least one receiver disposed in the support body and configured to support fiber optic equipment in a stackable shelf in a height space. The support member also comprises at least one second receiver disposed in the support body and configured to support one or more additional removable stacker assemblies each configured to support fiber optic equipment at one or more additional height spaces. The removable stacker assembly also comprises an attachment member configured to receive the support member. The attachment member comprises an attachment body. The attachment member is also comprised of at least one latch disposed in the attachment body and configured to be attached to at least one receiver in the stackable shelf to secure the attachment member receiving the support member to the stackable shelf.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIGS. 1A-1C are perspective, front, and side views, respectively, of an exemplary stackable shelf that can be movably inserted in a fiber optic housing and configured with stacker assemblies to support fiber optic equipment of height spaces;

FIGS. 2A-2C are perspective, top, and front views, respectively, of the stackable shelf in FIGS. 1A-1C supporting fiber optic panels configured with stacker assemblies to support fiber optic panels in a 1-U height space;

FIG. 2D is a perspective view of the stackable shelf configured with removable stacker assemblies to support fiber optic panels in a 1 U height space in FIGS. 2A-2C, with optical fibers routed through rear routing guides secured to the stackable shelf and terminated to the rear of fiber optic adapters disposed in the fiber optic panels;

FIG. 3A is a perspective view of the stackable shelf in FIGS. 2A-2C, but configured with elongated fiber routing guides attached to the stacker assemblies;

FIG. 3B is a perspective view of an alternative stackable shelf with rear routing guides secured to the stackable shelf and rotated approximately forty-five (45) degrees from the rear routing guides disposed in the stackable shelf in FIG. 3A;

FIG. 4 is a perspective view of the stackable shelf in FIGS. 1A-2D without any fiber optic equipment installed therein;

FIG. 5A is a bottom close-up perspective view of a front removable stacker assembly installed and secured to the stackable shelf in FIG. 4;

FIG. 5B is a top perspective view of the stackable shelf in FIG. 4 with the front removable stacker assembly in FIG. 5A attached to the mounting surface to support fiber optic panels in a 1 U height space;

FIG. 5C is a bottom close-up perspective view of a rear removable stacker assembly installed and secured to the stackable shelf in FIG. 4;

FIG. 5D is a top perspective view of the stackable shelf in FIG. 4 configured with the front removable stacker assembly and rear removable stacker assembly in FIG. 5C attached to the mounting surface to support fiber optic modules in a 1-U height space;

FIGS. 6A and 6B are perspective and side views, respectively, of the stackable shelf in FIGS. 1A-2D including front and rear removable stacker assemblies installed in the stackable shelf and supporting a fiber optic panel and a fiber optic module;

FIGS. 6C and 6D are front perspective and top views, respectively, of an exemplary fiber optic module that can be supported by the rear stacker assemblies installed in the stackable shelf in FIG. 4, as illustrated in FIGS. 6A and 6B;

FIG. 7 is a perspective view of the stackable shelf in FIGS. 1A-2D including front and rear removable stacker assemblies to support two fiber optic modules in a 1 U height space;

FIGS. 8A-8C are perspective, front, and rear views, respectively, of the stackable shelf in FIGS. 1A-2D including an additional front removable stacker assemblies to support fiber optic panels in a 2 U height space;

FIG. 9 is a perspective view of the stackable shelf in FIGS. 1A-2D configured with removable stacker assemblies to support an additional fiber optic panel and additional fiber optic module in a 2 U height space;

FIG. 10 is a perspective view of the stackable shelf in FIGS. 1A-2D configured with removable stacker assemblies to support additional fiber modules in a 2 U height space;

FIG. 11 is a perspective view of the stackable shelf in FIGS. 1A-2D configured with removable stacker assemblies to support additional fiber modules in a 3 U height space;

FIGS. 12A-12F are perspective exploded, assembled perspective, front, side, bottom, and top views, respectively, of a front removable stacker assembly;

FIG. 13 is a perspective view of an exemplary front routing guide in FIGS. 1A-2D positioned to be secured to the front stacker assembly in FIGS. 12A-12F installed in the stackable shelf of FIG. 4;

FIGS. 14A and 14B are side and rear views, respectively, of a front fiber routing guide that attaches to the front stacker assembly illustrated in FIG. 13;

FIGS. 15A and 15B are perspective and side views, respectively, of the front stacker assembly in FIGS. 12A-12F with an exemplary removable panel clip secured thereto to support securing fiber optic panels to the stackable shelf in FIG. 4;

FIGS. 16A-16E are perspective, right side, left side, top, and front views, respectively, of the removable panel clip;

FIGS. 17A-17F are exploded perspective, assembled perspective, top, side, front, and bottom views, respectively, of a rear removable stacker assembly;

FIGS. 18A-18D are perspective, front, top, and side views, respectively, of the fiber body holder in FIGS. 1A-2D;

FIG. 19A is a bottom close-up view of the fiber body holder in FIGS. 18A-18D installed and secured to the stackable shelf in FIG. 4;

FIG. 19B is a side view of the fiber body holder in FIGS. 18A-18D installed and secured to the stackable shelf in FIG. 4;

FIG. 20 is a perspective view of a second fiber body holder stacked on top of a first body holder in FIGS. 18A-18D installed and secured to the stackable shelf in FIG. 4;

FIG. 21 is a top close-up view of the right side of the stackable shelf illustrating an exemplary rail system configured to allow the stackable shelf to be secured in a fiber optic housing;

FIG. 22 is a side view of the right side, transparent view of the stackable shelf of FIGS. 1A-2D installed in an exemplary fiber optic housing;

FIG. 23 is a perspective view of the fiber optic housing that includes the stackable shelf in FIG. 22 with mounting brackets installed in a rear position of the fiber optic housing;

FIG. 24 is a perspective view of the fiber optic housing that includes the stackable shelf in FIG. 22 with mounting brackets installed in a front position on the fiber optic housing;

FIG. 25 includes perspective views of exemplary components used to provide a stackable shelf supporting fiber optic equipment in a fiber optic housing according to certain embodiments disclosed herein;

FIG. 26 is a perspective view of an alternative fiber optic housing configured to support fiber optic modules and fiber optic panels in a vertical orientation;

FIGS. 27A-27C are perspective, perspective close-up, and perspective close-up cut section views, respectively, of a removable panel clip installed in the fiber optic housing of FIG. 26 to enable the fiber optic housing to support fiber optic panels and fiber optic modules interchangably;

FIG. 28A is a perspective view of the fiber optic housing in FIG. 27A with the removable panel clips in FIGS. 27A-27C installed to support fiber optic panels;

FIG. 28B is a perspective view of the fiber optic housing in FIG. 27A with the removable panel clips in FIGS. 27A-27C installed and supporting fiber optic panels in the fiber optic housing;

FIG. 29 is a perspective view of an alternative exemplary removable panel clip installed in an alternative fiber optic housing to enable the fiber optic housing to interchangeably support fiber optic panels and fiber optic modules;

FIG. 30A-30D are bottom, side, front, and back views, respectively, of the removable panel clip in FIG. 29;

FIGS. 31A-1 and 31A-2 are top perspective views of front stacker assembly components that are configured to be assembled together to form an alternative assembled front stacker assembly that can be installed in a stackable shelf to support fiber optic equipment;

FIGS. 31B-1 and 31B-2 are bottom perspective views of front stacker assembly components in FIGS. 31A-1 and 31A-2, respectively, that are configured to be assembled together to form an alternative assembled front stacker assembly that can be installed in a stackable shelf to support fiber optic equipment;

FIGS. 31C-1 and 31C-2 are first side views of front stacker assembly components in FIGS. 31A-1 and 31A-2, respectively, that are configured to be assembled together to form an alternative assembled front stacker assembly that can be installed in a stackable shelf to support fiber optic equipment;

FIGS. 31D-1 and 31D-2 are second side views of front stacker assembly components in FIGS. 31A-1 and 31A-2, respectively, that are configured to be assembled together to form an alternative assembled front stacker assembly that can be installed in a stackable shelf to support fiber optic equipment;

FIGS. 31E-1 and 31E-2 are bottom views of front stacker assembly components in FIGS. 31A-1 and 31A-2, respectively, that are configured to be assembled together to form an alternative assembled front stacker assembly that can be installed in a stackable shelf to support fiber optic equipment;

FIGS. 31F-1 and 31F-2 are top views of front stacker assembly components in FIGS. 31A-1 and 31A-2, respectively, that are configured to be assembled together to form an alternative assembled front stacker assembly that can be installed in a stackable shelf to support fiber optic equipment;

FIGS. 32A-1 and 32A-2 are top perspective views of rear stacker assembly components that are configured to be assembled together to form an alternative assembled rear stacker assembly that can be installed in a stackable shelf to support fiber optic equipment;

FIGS. 32B-1 and 32B-2 are first side views of rear stacker assembly components in FIGS. 32A-1 and 32A-2, respectively, that are configured to be assembled together to form an alternative assembled rear stacker assembly that can be installed in a stackable shelf to support fiber optic equipment;

FIGS. 32C-1 and 32C-2 are second side views of rear stacker assembly components in FIGS. 32A-1 and 32A-2, respectively, that are configured to be assembled together to form an alternative assembled rear stacker assembly that can be installed in a stackable shelf to support fiber optic equipment;

FIGS. 32D-1 and 32D-2 are top views of rear stacker assembly components in FIGS. 32A-1 and 32A-2, respectively, that are configured to be assembled together to form an alternative assembled rear stacker assembly that can be installed in a stackable shelf to support fiber optic equipment;

FIGS. 32E-1 and 32E-2 are third side views of rear stacker assembly components in FIGS. 32A-1 and 32A-2, respectively, that are configured to be assembled together to form an alternative assembled rear stacker assembly that can be installed in a stackable shelf to support fiber optic equipment; and

FIGS. 32F-1 and 32F-2 are bottom views of rear stacker assembly components in FIGS. 32A-1 and 32A-2, respectively, that are configured to be assembled together to form an alternative assembled rear stacker assembly that can be installed in a stackable shelf to support fiber optic equipment.

### DETAILED DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

Embodiments disclosed in the detailed description also include stackable shelves for a fiber optic housing and related components and methods. In one embodiment, a stackable shelf for a fiber optic housing is provided. The stackable shelf comprises a mounting surface. The stackable shelf also comprises one or more removable stacker assemblies stacked above the mounting surface, each configured to support fiber optic equipment in one or more height spaces. The one or more removable stacker assemblies are further configured to support one or more additional removable stacker assemblies each configured to support fiber optic equipment at one or more additional height spaces.

In another embodiment, a stackable shelf for a fiber optic housing is provided. The stackable shelf comprises a mounting surface, a combination of one or more front removable stacker assemblies, and/or a combination of one or more rear removable stacker assemblies. The mounting surface is movably attached to the fiber optic housing. The combination of one or more front removable stacker assemblies and the combination of one or more rear removable stacker assemblies removably attach to the stackable shelf to allow the stackable shelf to be configured in one of a U size (e.g., 1 U, 2 U, 3 U, or any U, or fractional Us) shelf size within the fiber optic housing.

The designation “U” refers to a standard equipment shelf size of a fiber optic equipment rack or a cabinet. This may also be referred to as “RU.” For example, an equipment rack may support 1 U-sized shelves, with “U” equal to a standard 1.75 inches in height and nineteen (19) inches in width. In certain applications, the width of “U” may be twenty-three (23) inches. Typically, the more rack space (the more “U's”) a fiber optic housing takes up, the higher the fiber capacity in the fiber optic housing.

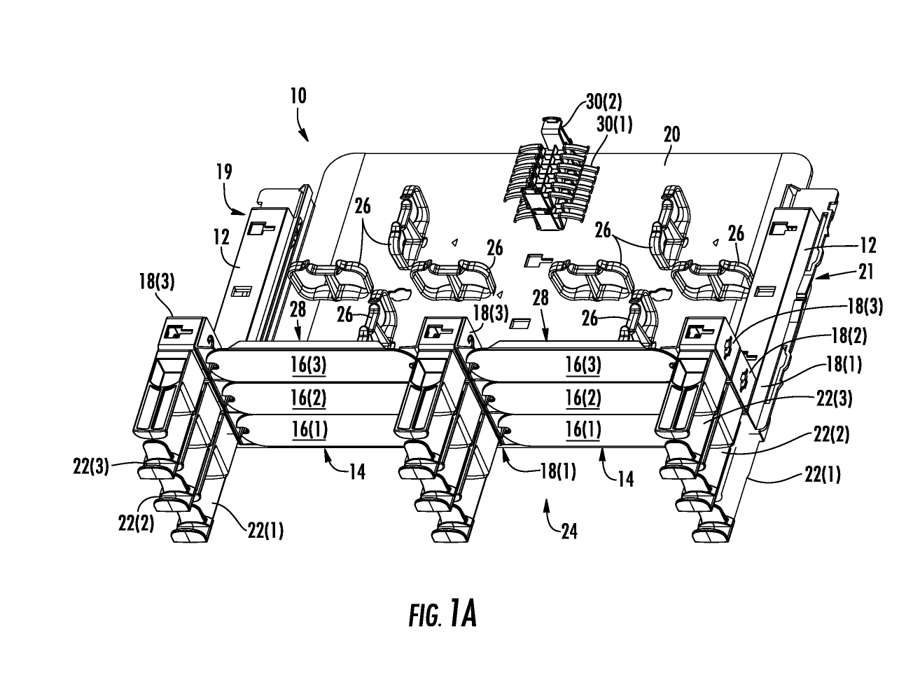

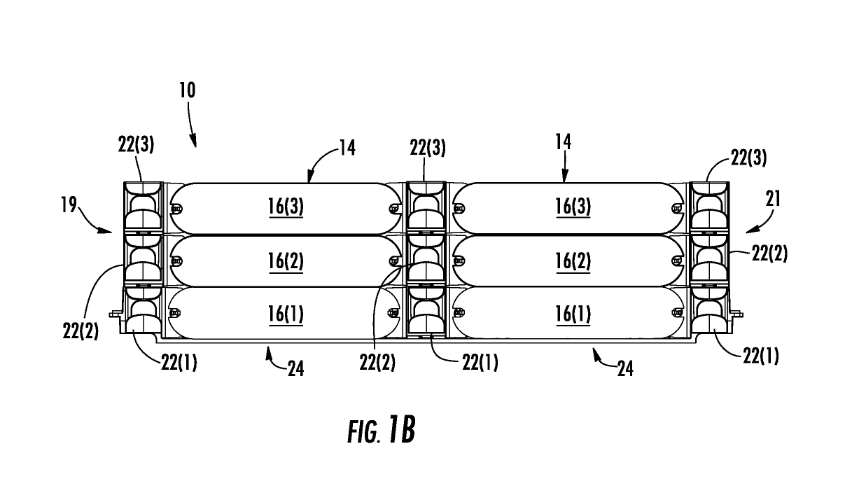

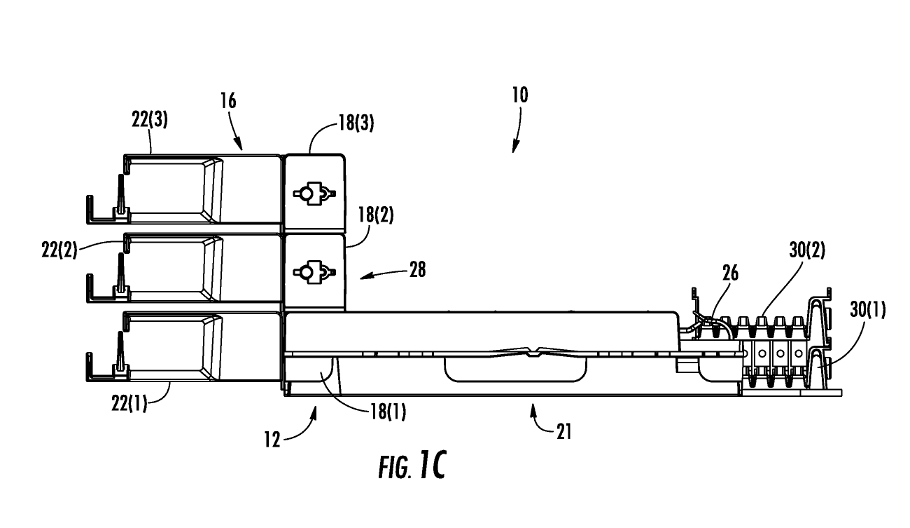

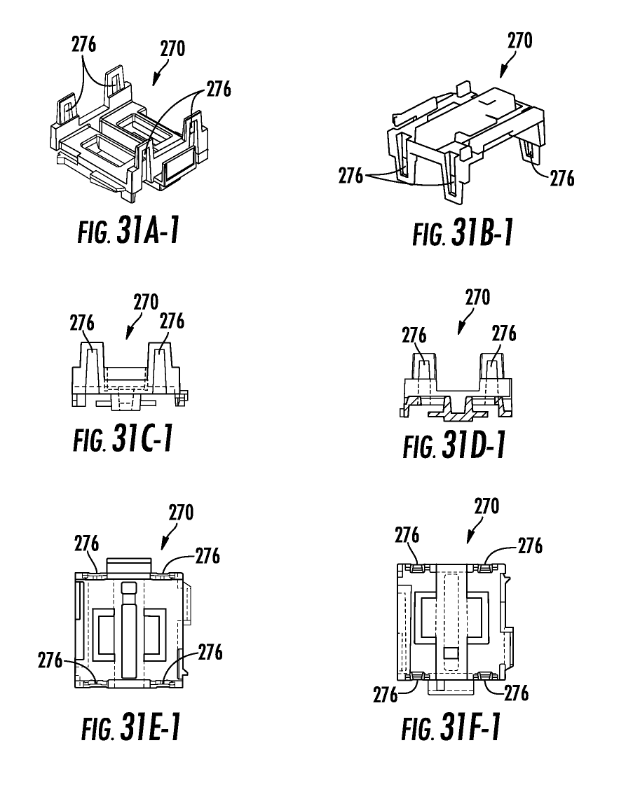

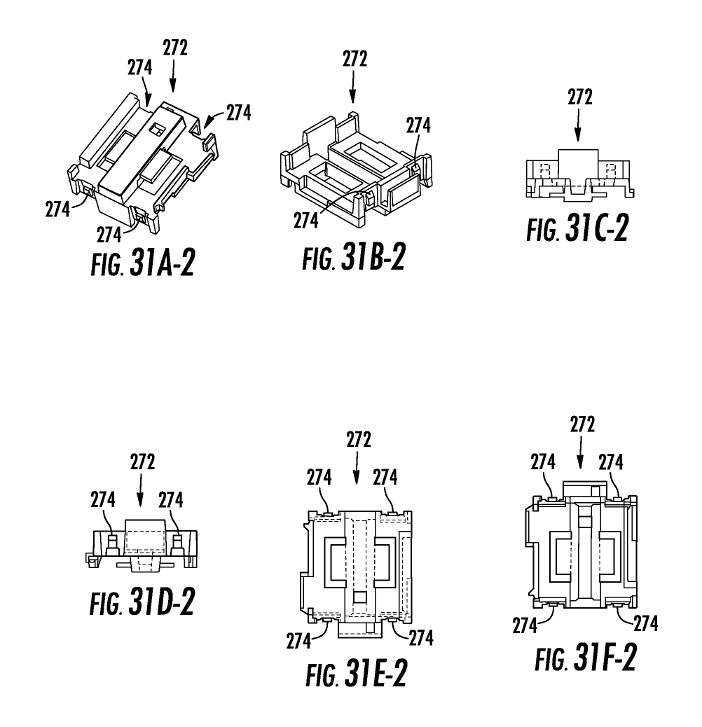

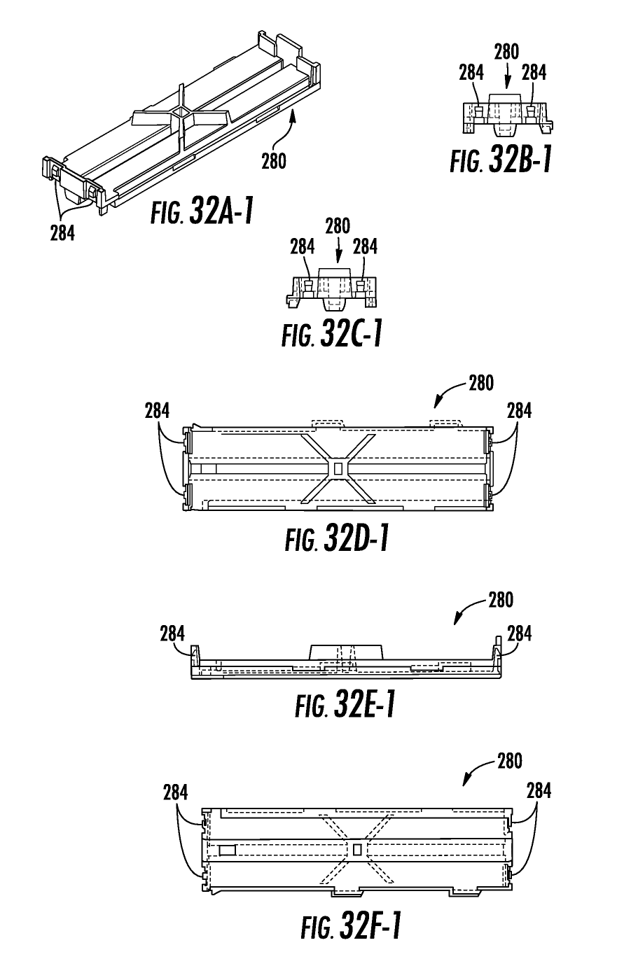

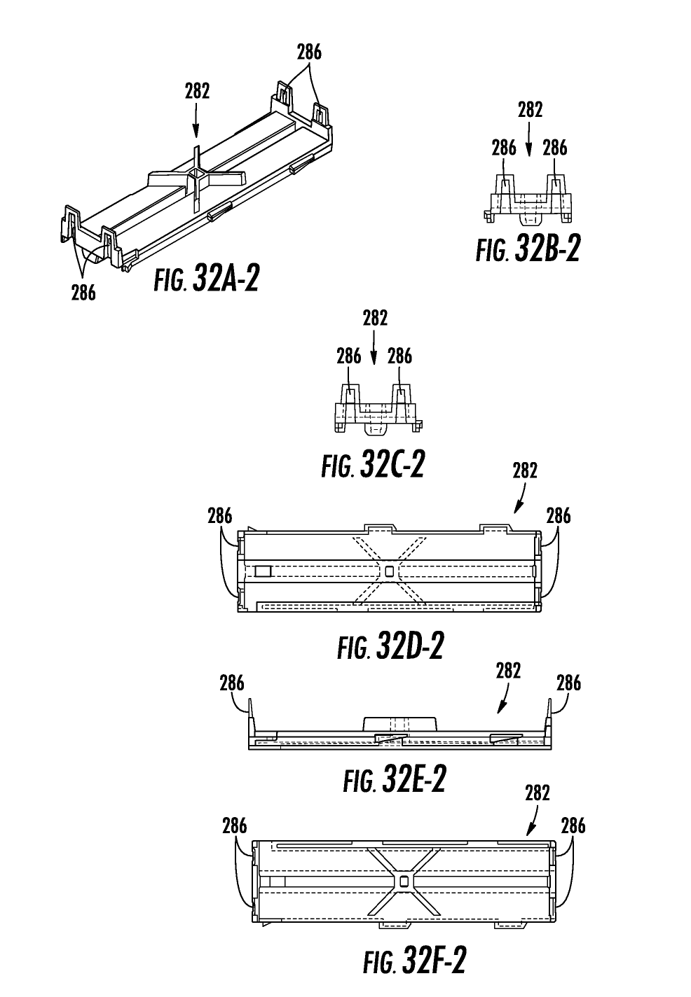

FIGS. 1-32B illustrate respectively an exemplary stackable shelf configured with one or more removable stacker assemblies to support fiber optic equipment of varying heights. A stacker assembly is any component, member or assembly that is configurable to support fiber optic equipment at a different desired height or heights (e.g., U spaces) from a surface, including but not limited to a mounting surface provided for a fiber optic shelf. The stackable shelf may be movably mounted in a fiber optic housing. The stackable shelf contains features that allow fiber optic equipment to be stacked at different height spaces in the stackable shelf thereby increasing its rack unit height by using multiples of the same components. Depending on the nature of an installation, a stackable shelf configured for a 1 U fiber optic housing could also be converted for use in a higher U space fiber optic housing, such as 2 U, 3 U, or greater U size, and fractional U sizes (e.g., ⅓ U, ⅔ U, 1⅓ U, 2⅔ U, etc.) as examples, by stacking or removing these components in the factory or in the field at the installation site, as needed or desired. The stackable shelves disclosed herein are shown as being configured in 1 U, 2 U, and 3 U sizes, but note that any U sizes are possible greater than 3 U and fractional U sizes below and above 1 U, for example ⅓ U, ⅔ U, ¾ U, ⅔ U, 1⅓ U, 2⅔ U, 3½ U, etc. The stackable shelves and the heights at which they can support fiber optic equipment is not limited in this manner.

In this regard, FIGS. 1A-1C are perspective, front, and side views, respectively, of an exemplary stackable shelf 10 configured to be movably inserted in a fiber optic housing. The stackable shelf 10 is configured with stacker assemblies 12 to support fiber optic equipment 14 in multiple U height spaces depending on how the stackable shelf 10 is configured. In this example, the fiber optic equipment 14 is comprised of fiber optic panels 16(1)-16(3). Each fiber optic panel 16(1)-16(3) is of 1 U height space. Fiber optic panel 16(1) is disposed in a first 1 U height space. Fiber optic panel 16(2) is stacked on top of the fiber optic panel 16(1) and is disposed in a second 1 U height space. Fiber optic panel 16(3) is stacked on top of the fiber optic panel 16(2) and is disposed in a third 1 U space.

The designation (1) for a particular component or part referenced in this application is to signify that such component is located adjacent in the first or bottom U space of the stackable shelf 10 in this example. The designation (2) for a particular component or part referenced in this application is to signify that such component is located adjacent in the second U space of the stackable shelf 10 in this example, stacked above components disposed in the first U space of the stackable shelf 10 in this example. The designation (3) for a particular component or part referenced in this application is to signify that such component is located adjacent in the third U space of the stackable shelf 10 in this example, stacked above components disposed in the second U space of the stackable shelf 10 in this example.

In this embodiment as illustrated in FIGS. 1A-1C, to support the fiber optic panels 16(1)-16(3) in the stackable shelf in a 3 U configuration, front stacker assemblies 18(1)-18(3) are stacked on top of each other about a mounting surface 20 to support the three (3) fiber optic panels 16(1)-16(3) to a 3 U height space. In this embodiment, three (3) front stacker assemblies 18(1) are provided in the mounting surface 20 to support two (2) fiber optic panels 16(1). Two (2) front stacker assemblies 18(1) are integrated into the stacker assemblies 12 that are integrated on a left end 19 and a right end 21 of the mounting surface 20, and which may or may not be configured to be removable from the mounting surface 20. The stacker assembly 18(1) disposed in the center section of the mounting surface 20 is removably attached to the mounting surface between the left end 19 and the right end 21. In this manner, two (2) fiber optic panels 16(1) can be supported by the stackable shelf 10 in a 1 U height space, as illustrated in FIGS. 1A-1C, since two (2) stacker assemblies 18(1) are provided to support one (1) fiber optic panel 16(1) therebetween as will be described in more detail below. As will also be described in more detail below, the stackable shelf 10 can also be configured to support fiber optic modules (and/or fiber optic cassettes) in multiple U height spaces, including to height spaces less than 3 U and to height spaces greater than 3 U.

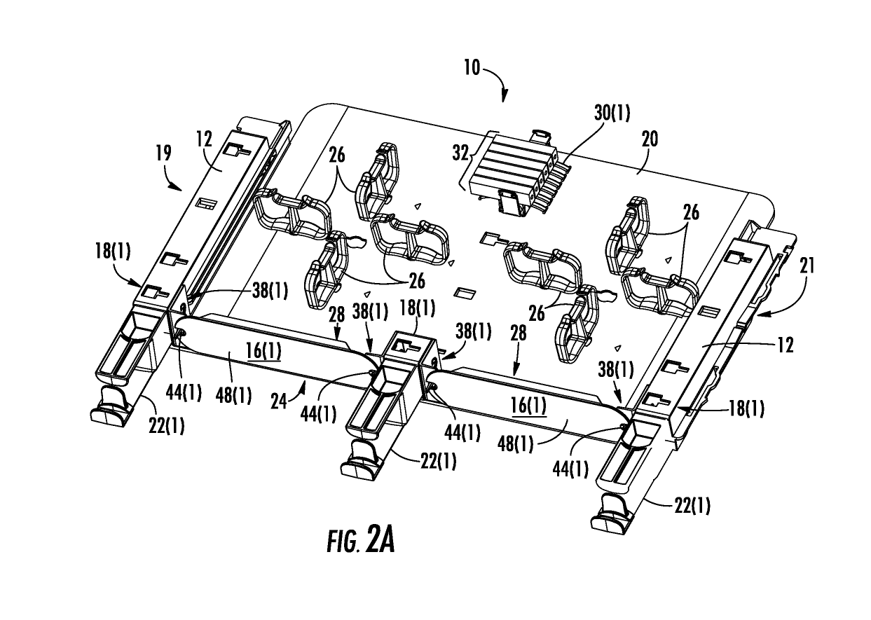

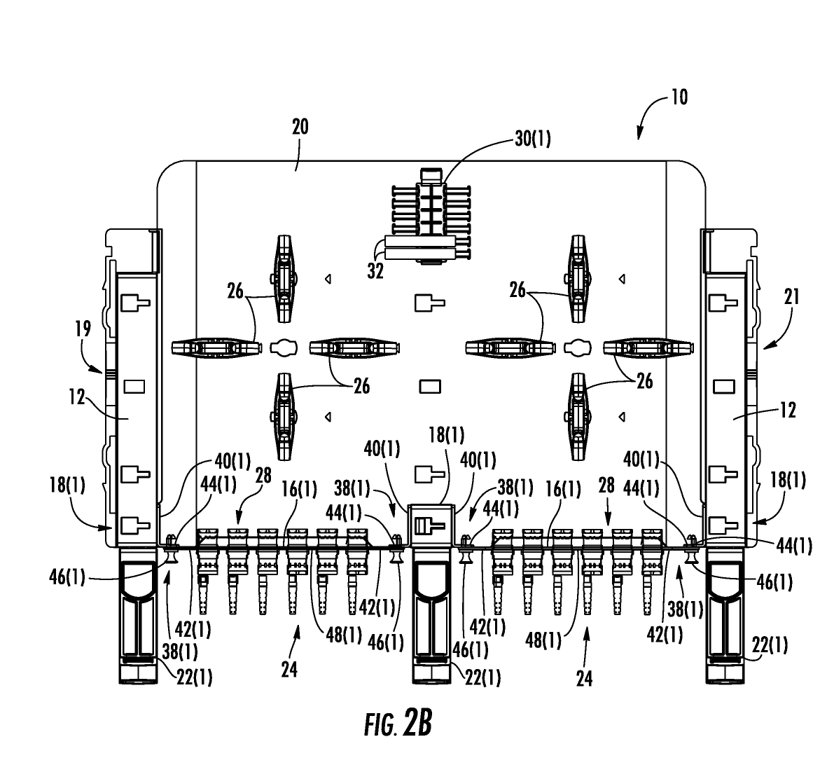

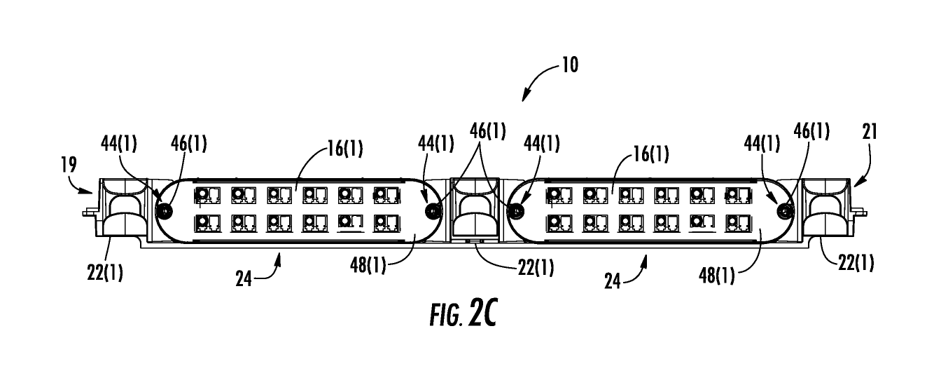

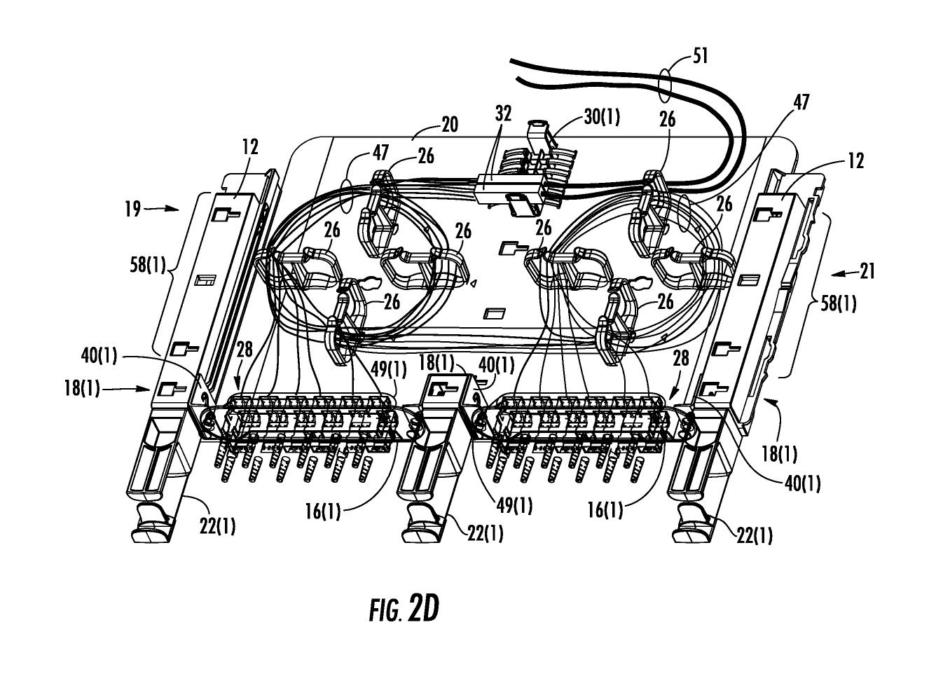

Before discussing the components that allow the stackable shelf 10 in FIGS. 1A-1C to be configured to support the fiber optic equipment 14 in multiple U spaces with regard to FIGS. 2A-28B, some other components that can be supported by the stackable shelf 10 and illustrated in FIGS. 1A-1C are introduced. For example, as will be described below and illustrated in FIGS. 14-15B, removable front fiber routing guides 22(1)-22(3) can be attached to the front stacker assemblies 18(1)-18(3) to route optical fibers connected to the fiber optic equipment 14 in a front 24 of the mounting surface 20 supported by the stackable shelf 10. As another example, removable and rotatable fiber routing guides 26 can be attached to the mounting surface 20 to route optical fibers connected to the fiber optic equipment 14 in a rear 28 of the fiber optic panels 16(1). More information regarding the rotatable fiber routing guides 26 is described in related U.S. Provisional Patent Application Ser. No. 61/329,898.

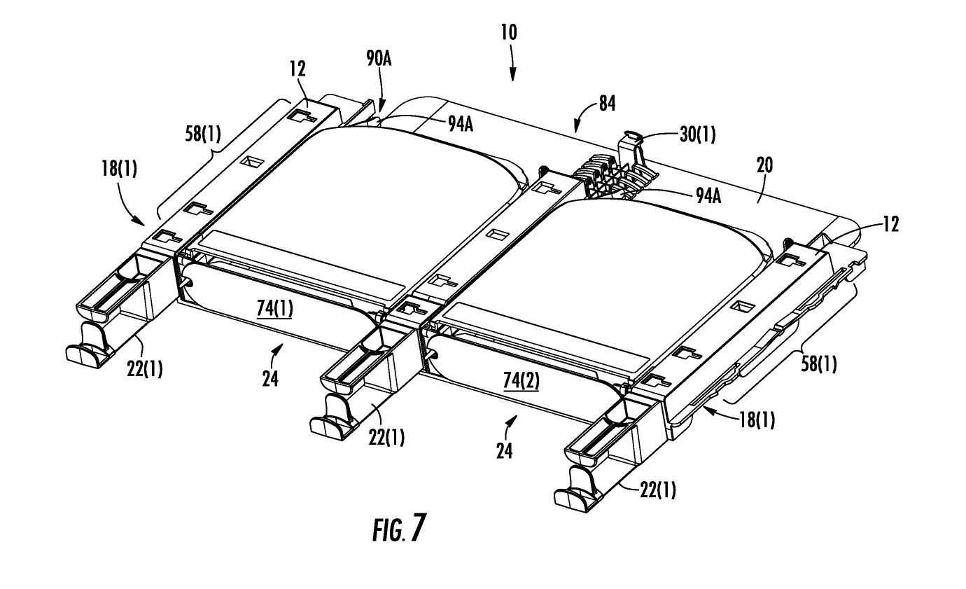

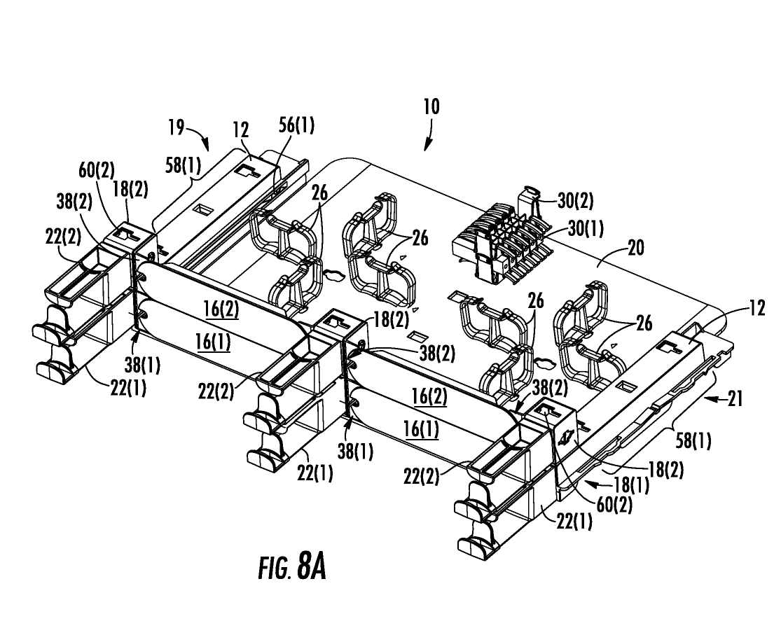

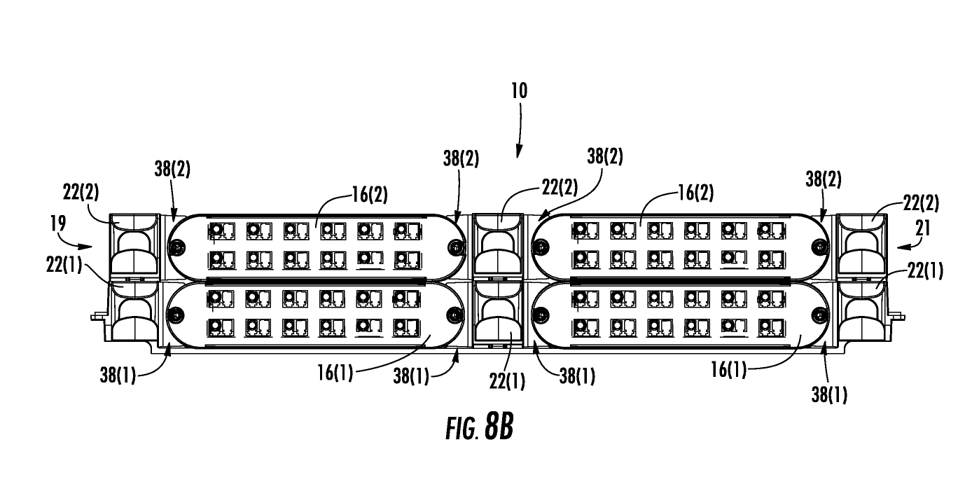

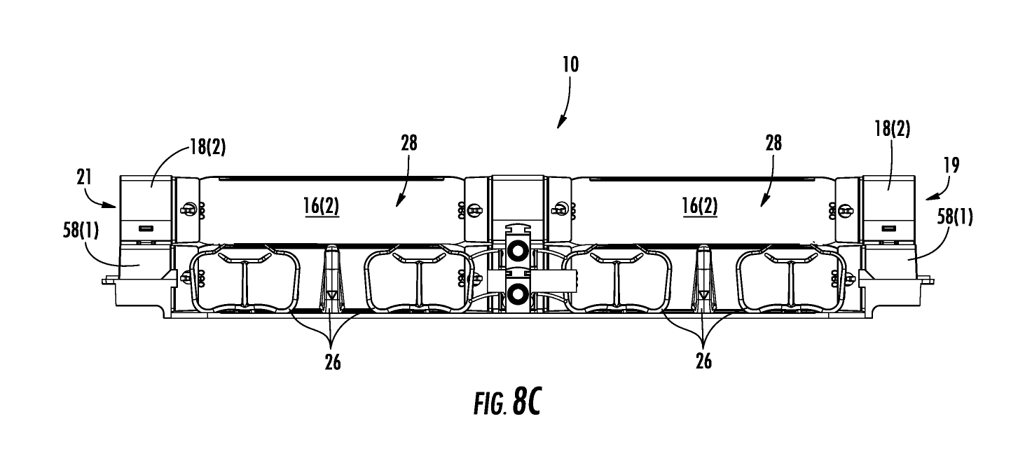

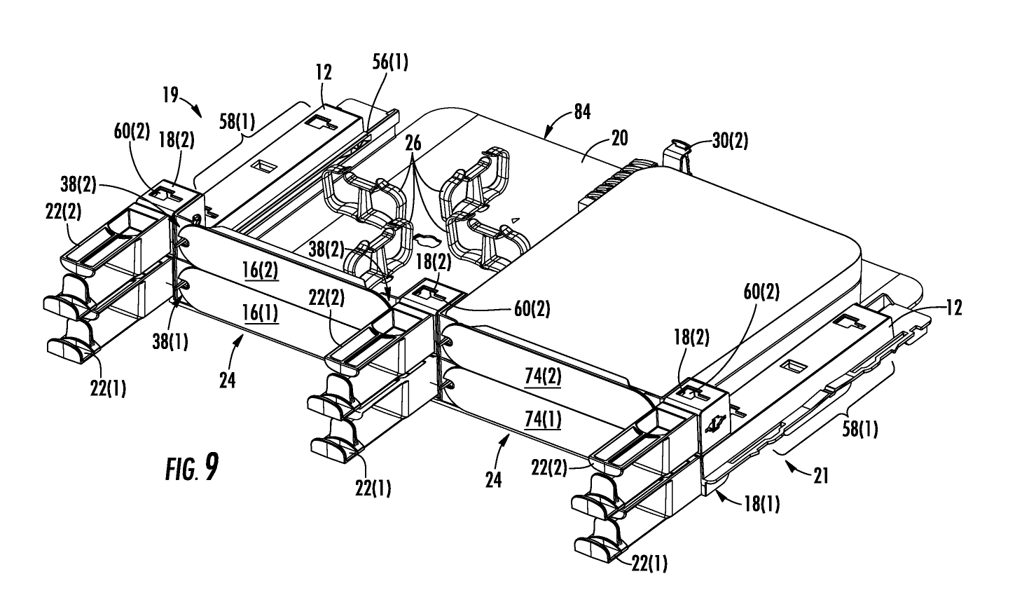

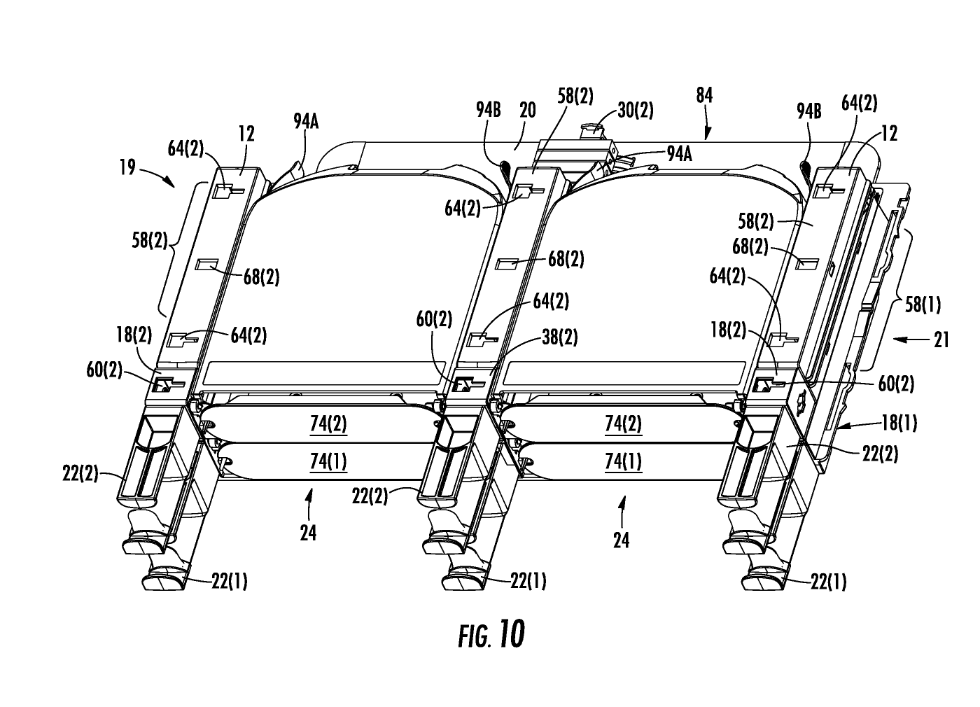

As another example that will be described in more detail below and illustrated in FIGS. 11A-13, fiber body holders 30(1)-30(2) can also be provided in the stackable shelf 10. The fiber body holders 30(1)-30(2) are configured to support fiber bodies 32, which may be fan-out bodies or furcation bodies, as illustrated in FIGS. 2A, 2B, and 10A, in optical fibers connected to the rear 28 of the fiber optic equipment 14. A first fiber body holder 30(1) is attached to the mounting surface 20 to support the fiber bodies 32. If desired or needed, a second fiber body holder 30(2) is stacked on top of the first body holder 30(1) to provide for the ability to support additional fiber bodies 32.

FIGS. 2A-2C are perspective, top, and front views, respectively, of the stackable shelf 10 in FIGS. 1A-1C after the stackable shelf 10 has been configured to support fiber optic panels 16(1) in a 1 U height space. The stackable shelf 10 illustrated in FIGS. 2A-2D can then be left as only support fiber optic panels 16(1) in a 1 U height space, or additional front stacker assemblies 18 (e.g., removable front stacker assemblies 18(2), 18(3)) can be stacked on top of the front stacker assemblies 18(1) to allow additional fiber optic panels 16 (e.g., fiber optic panels 16(2), 16(3)) to be supported by the stackable shelf 10 in additional U height spaces about the fiber optic panels 16(1).

FIGS. 2A-2D also illustrate how the fiber optic panels 16(1) are supported by the front stacker assemblies 18(1). As illustrated therein, first surfaces 40(1) of the removable panel clips 38(1) are attached to the front stacker assemblies 18(1). As illustrated in FIG. 2B, the removable panel clips 38(1) also include second surfaces 42(1) with receivers 44(1) disposed therein that are configured to receive an insert 46(1) disposed in a front plate 48(1) of the fiber optic panels 16(1) to attach and retain the fiber optic panels 16(1) to the removable panel clip 38(1). Thus, the fiber optic panels 16(1) are secured to the stackable shelf 10 by attaching to the removable panel clips 38(1), which are in turn attached to the front stacker assemblies 18(1), which are in turn attached to the mounting surface 20. In this embodiment of the fiber optic panels 16(1), the insert 46(1) is comprised of a plunger for retention of the fiber optic panel 16(1) to the removable panel clips 38(1). However, other types of inserts 46(1) could be employed.

FIG. 2D is a perspective view of the stackable shelf 10 with optical fibers 47 routed through fiber routing guides 26 terminated to the rear 28 of fiber optic adapters 49(1) disposed in the fiber optic panels 16(1). The optical fibers 47 extend from the fiber bodies 32 that are installed and supported in the fiber body holder 30(1), as also illustrated in FIG. 2D. The fiber bodies 32 are connected to fiber optic cables 51 that contain the optical fibers 47.

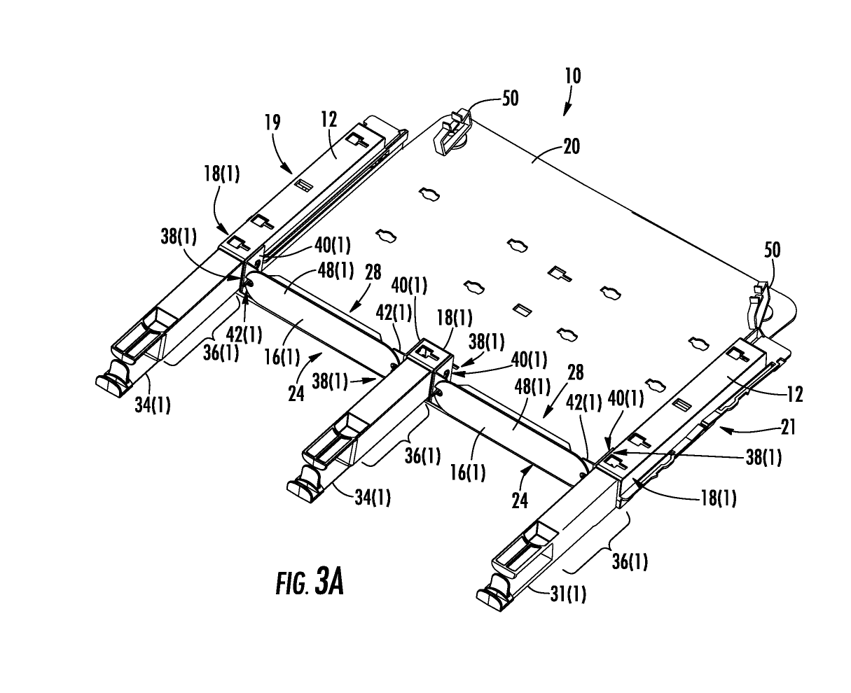

FIG. 3A is a perspective view of the stackable shelf 10 in FIGS. 2A-2D, but configured with alternative elongated fiber routing guides 34(1) that include elongated sections 36(1) to extend the fiber routing guides 34(1) farther away from the mounting surface 20. FIG. 3B illustrates an alternative rotatable routing guide 50 that may be attached to a mounting surface 20′ of an alternative stackable shelf 10′ to route optical fibers connected to a rear 28′ of a fiber optic panel 16(1)′.

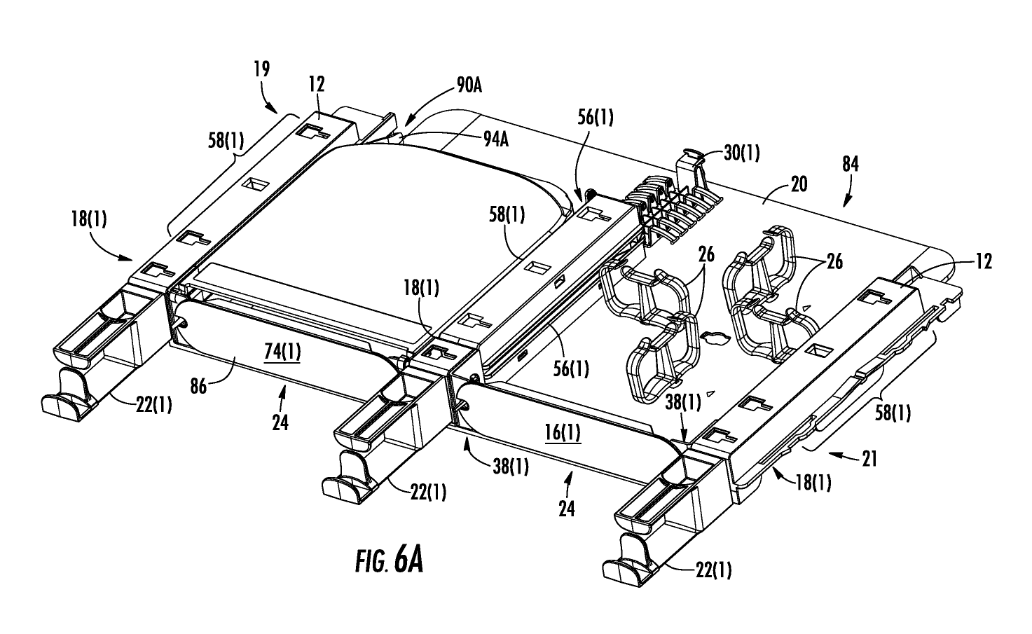

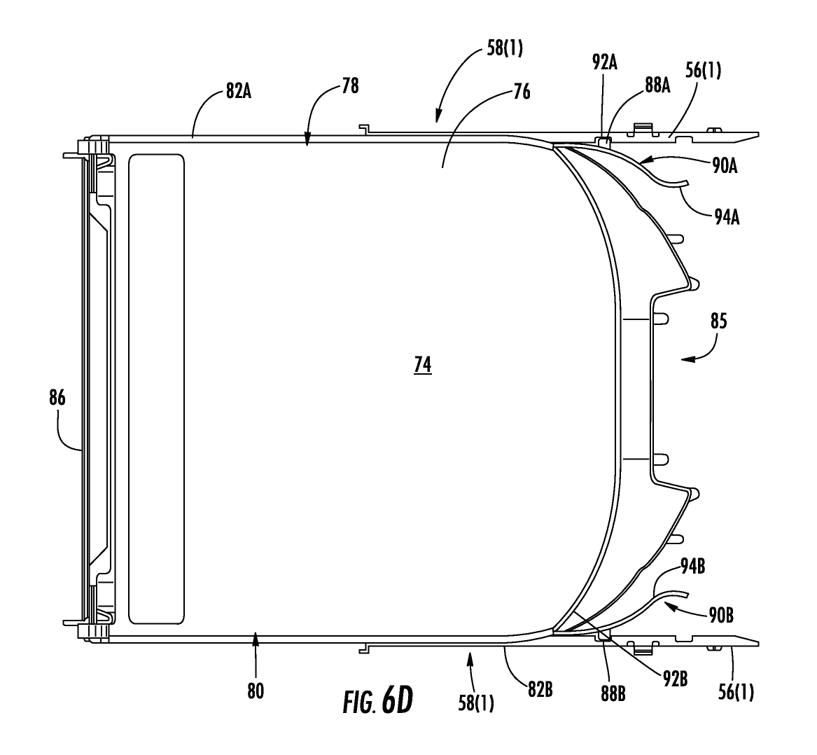

FIG. 4 is a perspective view of the stackable shelf 10 in FIGS. 1A-2D without any fiber optic equipment installed therein. FIG. 4 is provided as a starting point to describe how stacker assemblies and related components are added and stacked on the mounting surface 20 of the stackable shelf 10 to configure the stackable shelf 10 to support fiber optic equipment of varying U height spaces. As illustrated in FIG. 4, stacker assemblies 12 are integrated into the mounting surface 20. The stacker assemblies 12 are configured to support either the fiber optic panels 16(1) or fiber optic modules in this embodiment. To support fiber optic panels 16(1), a receiver 52(1) is disposed in a side 54(1) of the front stacker assembly 18(1) portion of the stacker assembly 12 to receive the removable panel clips 38(1) illustrated in FIGS. 2A-2D. More detail and information regarding the removable panel clips 38(1) being attached to the front stacker assembly 18(1) is described below and illustrated in FIGS. 9A-10E. If a fiber optic module(s) is desired to be supported, the removable panel clips 38(1) are not employed. Instead, the fiber optic module(s) includes a rail guide that is configured to receive a rail 56(1) disposed in a rear stacker assembly 58(1) provided as a portion of the stacker assembly 12. More information regarding installing a fiber optic module receiving the rail 56(1) disposed in the rear stacker assembly 58(1) to support the fiber optic module in the stackable shelf 10 is illustrated in more detail below in FIGS. 6-7B, 9-11 and 13A-13F.

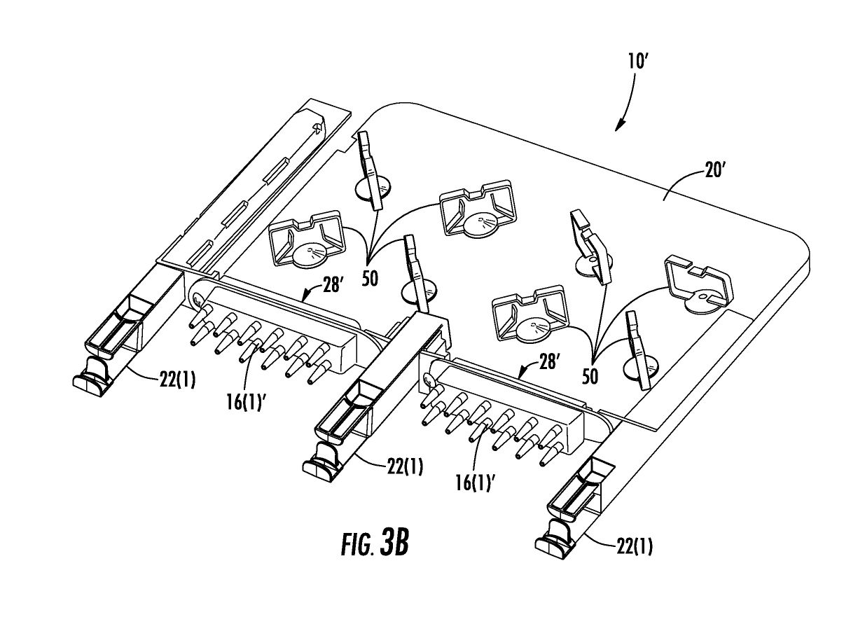

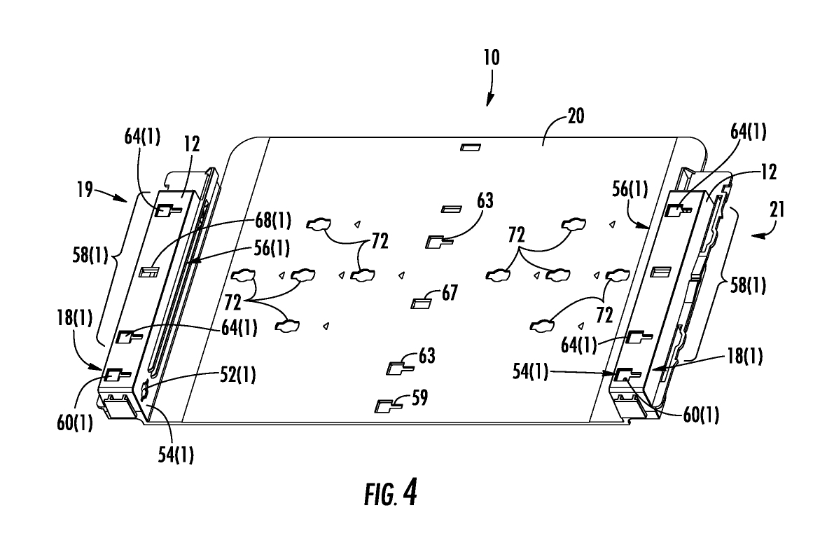

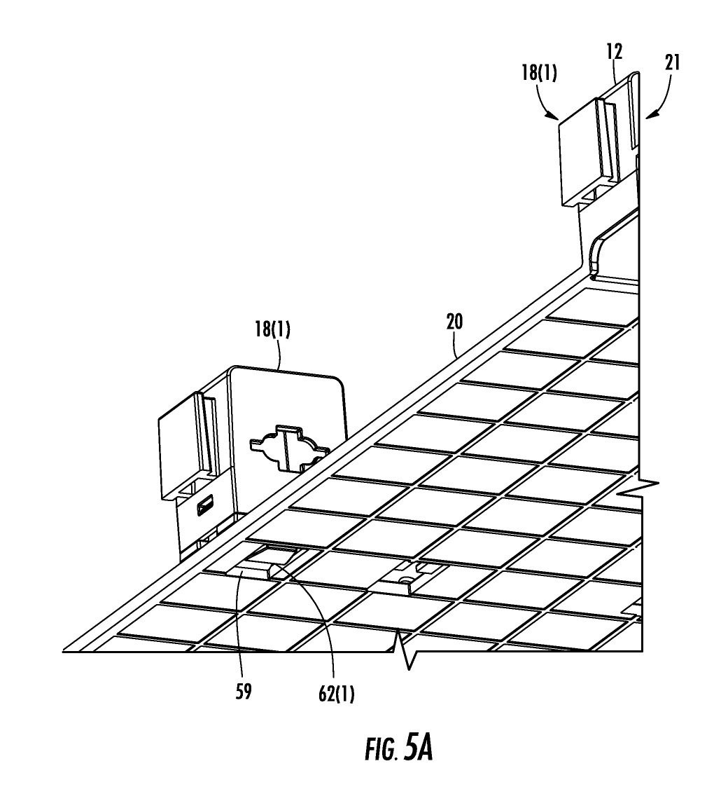

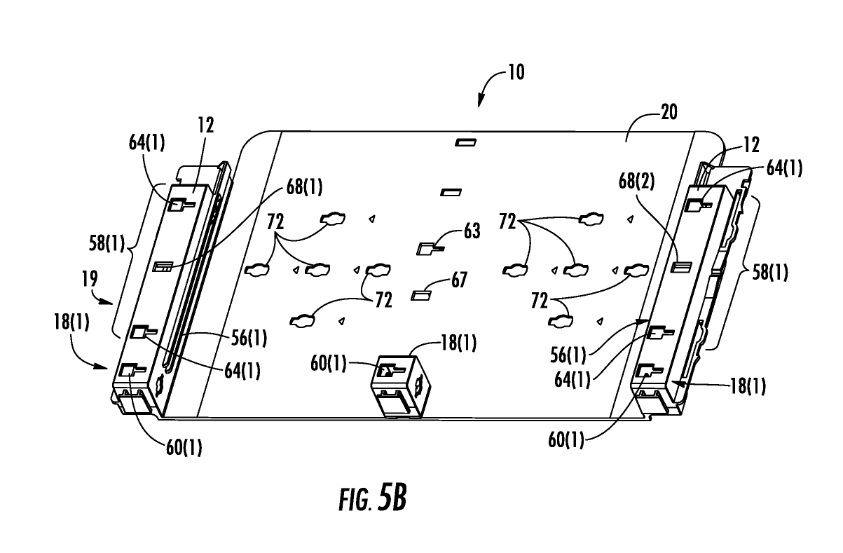

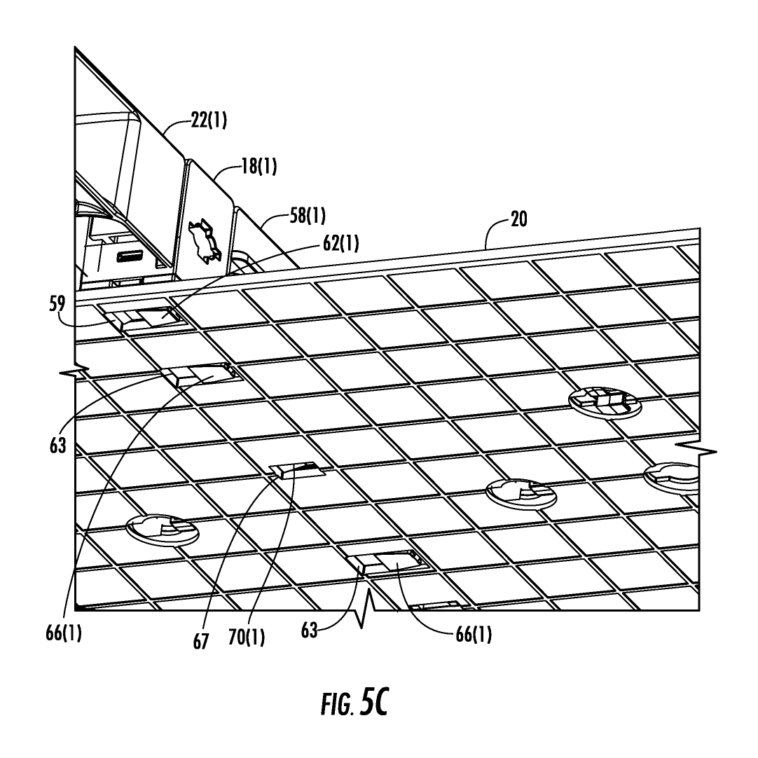

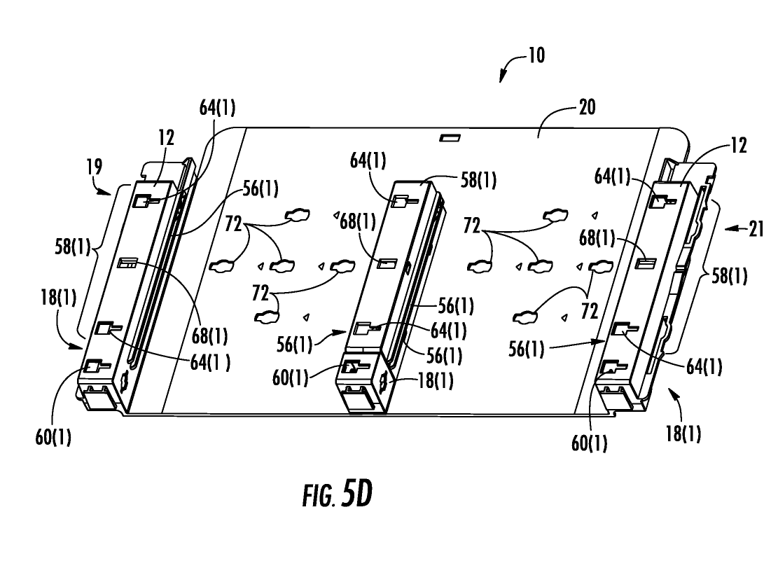

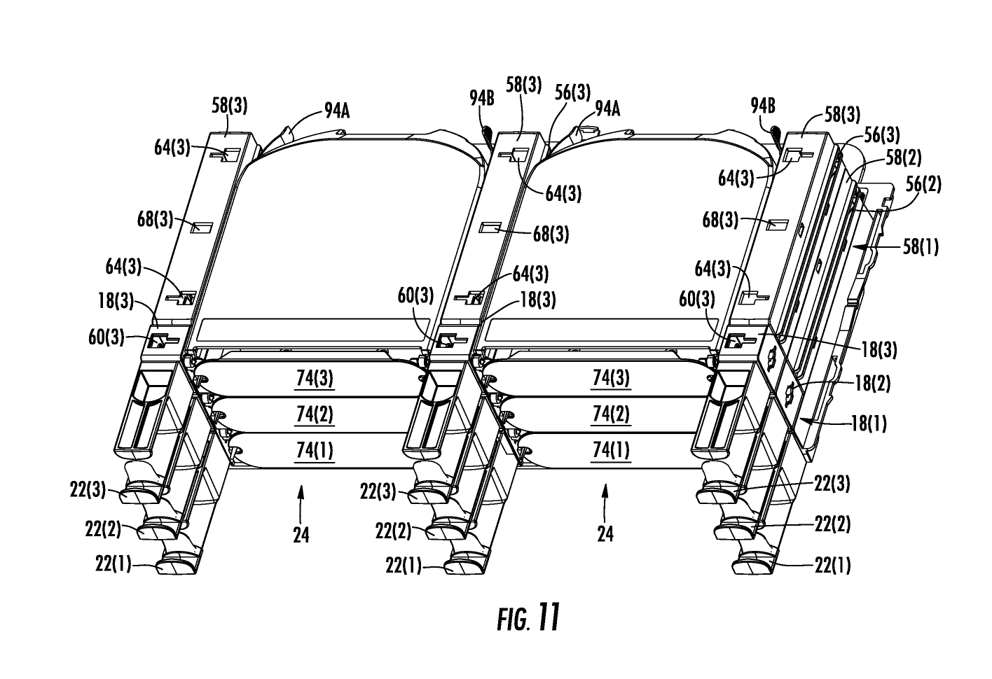

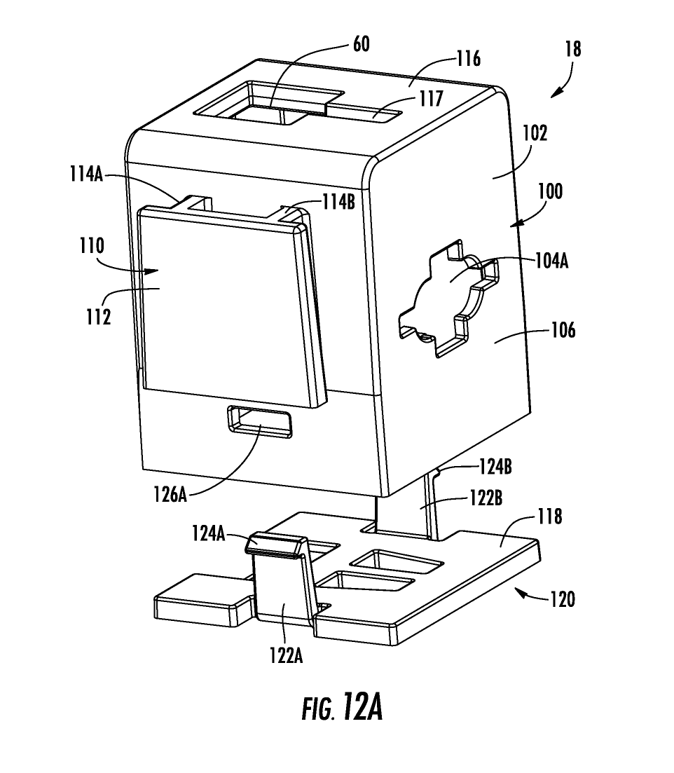

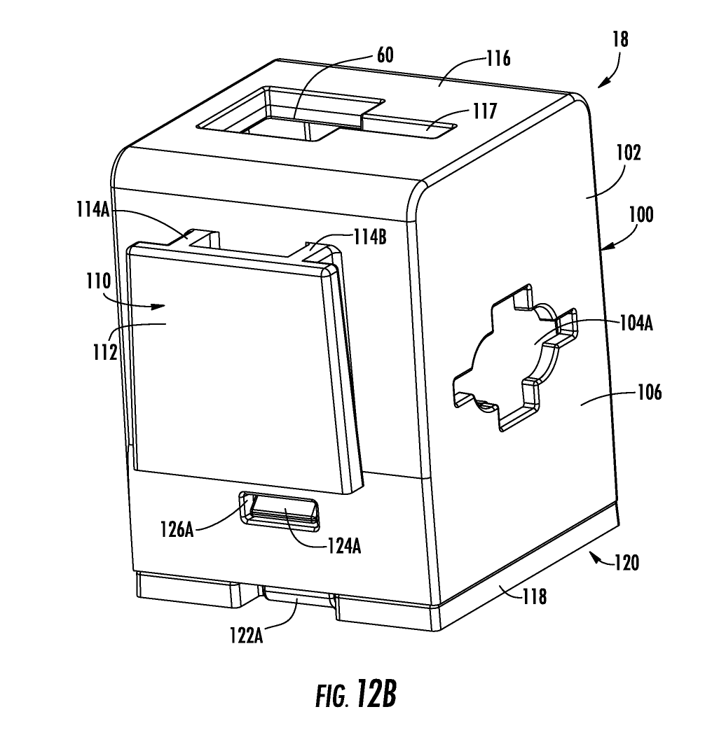

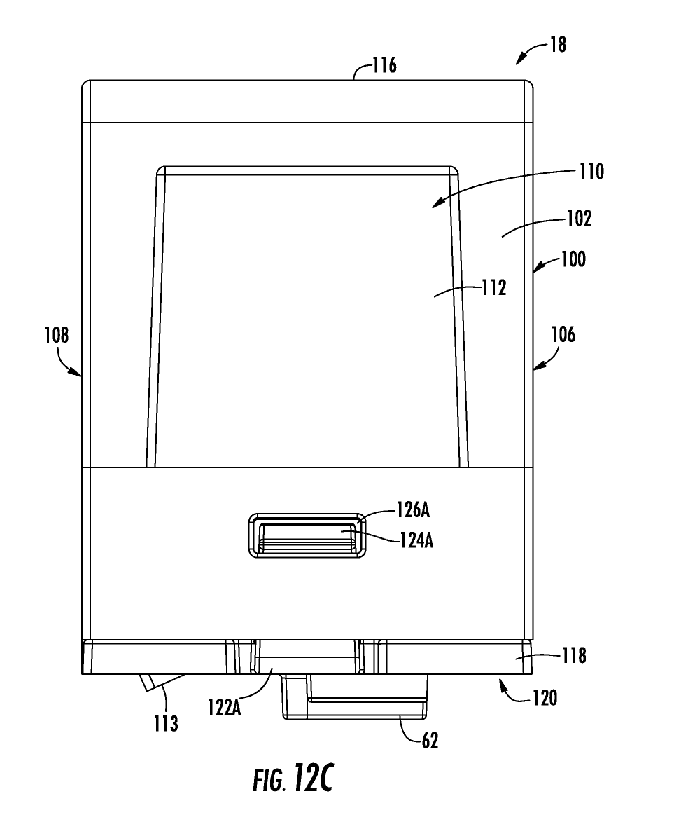

With continuing reference to FIG. 4, to support attaching a front stacker assembly 18(1) between the front stacker assemblies 18(1) disposed on the ends 19, 21 of the mounting surface 20 to support the fiber optic panels 16(1) in FIGS. 1A-2D, the receivers 59 are disposed in the mounting surface 20. As illustrated in FIG. 5A and described in more detail in FIGS. 5A-5B and 12A-12F, the bottom of the front stacker assemblies 18(1) include a latch 62(1) that is configured to be received and secured in the receiver 59 to attach additional front stacker assemblies 18(1) in the mounting surface 20 to support the fiber optic panels 16(1). An additional front stacker assembly 18(1) attached to the mounting surface 20 is illustrated in FIG. 5B.

Similarly, to support attaching an additional removable rear stacker assembly 58(1) between the non-removable rear stacker assemblies 58(1) disposed on the ends 19, 21 of the mounting surface 20 to support fiber optic modules, receivers 64(1) are disposed in the mounting surface 20. As illustrated in FIG. 5C and described in more detail in FIGS. 13A-13F, the bottom of the rear stacker assembly 58(1) include latches 66(1) that are configured to be received and secured in receivers 63 to attach an additional rear stacker assembly 58(1) in the mounting surface 20 to support fiber optic modules. An additional receiver 67 is disposed in the mounting surface 20 to receive an additional latch 70(1) disposed in the bottom of the rear stacker assembly 58(1). An additional rear stacker assembly 58(1) attached to the mounting surface 20 is illustrated in FIG. 5D. Also, receivers 72 in the form of openings are disposed in the mounting surface 20 to receive the removable fiber routing guides 26 illustrated in FIGS. 1A-2D.

With reference to FIGS. 4, 5B, and 5D, to support allowing stacking additional front stacker assemblies 18 on top of the front stacker assemblies 18(1) to support additional fiber optic panels 16 at U height spaces above the U height space of the stacker assemblies 12 (e.g., fiber optic panels 16(2) and 16(3) in FIGS. 1A-1C), receivers 60(1) are also disposed in the top of the front stacker assemblies 18(1). As illustrated in FIG. 5A, the latch 62 disposed in the bottom of the front stacker assembly 18(1) is configured to be received and secured in the receivers 60(1) to support stacking additional front stacker assemblies 18 on top of the front stacker assembly 18(1).

Similarly, to support stacking additional rear stacker assemblies 58 on top of the rear stacker assemblies 58(1) to support additional fiber optic modules at U height spaces above the U height space of the stacker assemblies 12, receivers 64(1) are disposed in the top of the rear stacker assemblies 58(1). In this embodiment, the receivers 64(1) are of the same design as the receivers 60(1). As illustrated in FIG. 5C, the bottom of the rear stacker assemblies 58 include the latches 66(1) that are configured to be received and secured in the receivers 64(1) to support stacking additional rear stacker assemblies 58 on top of the rear stacker assembly 58(1). An additional receiver 68(1) is also disposed in the rear stacker assemblies 58(1) configured to receive an additional latch 70, as illustrated in FIG. 5C, disposed in the bottom of the rear stacker assemblies 58 stacked on top of the rear stacker assembly 58(1). In this embodiment, the additional receiver 70(1) is of a different design from the receivers 60(1), 64(1).

FIGS. 6A and 6B are perspective and side views, respectively, of the stackable shelf 10 in FIGS. 1A-2D including front stacker assemblies 18(1) and rear stacker assemblies 58(1) installed in the stackable shelf 10. The stackable shelf 10 is supporting both a fiber optic panel 16(1) and a fiber optic module 74(1) illustrated in FIGS. 6C and 6D in the same height space. FIG. 7 is a perspective view of the stackable shelf 10 in FIGS. 1A-2D including front stacker assemblies 18(1) and rear stacker assemblies 58(1) installed in the stackable shelf 10 supporting two (2) fiber optic modules 74(1), 74(2) in the same height space.

As illustrated in the front perspective and top views of the fiber optic module 74 in FIGS. 6C and 6D, respectively, the fiber optic module 74 includes a housing 76 that includes a first end 78 and a second end 80. Rails guides 82A, 82B are disposed in the housing 76 on the first end 78 and the second end 80 of the housing 76, respectively. Thus, when a rear portion 85 of the fiber optic module 74 is inserted between rear stacker assemblies 58(1) from the front 24 of the mounting surface 20, the rail guides 82A, 82B of the fiber optic module 74 are aligned with the rails 56(1) in the rear stacker assemblies 58(1). As illustrated in FIGS. 6A, 6D, and 7, the rail guides 82A, 82B receive the rails 56(1). The fiber optic module 74 can be slid back from the front 24 of the mounting surface 20 to a rear 84 of the mounting surface 20, as illustrated in FIG. 6A, until a front side 86 of the fiber optic module 74 is located adjacent to the front stacker assembly 18(1) on the ends 19, 21 of the mounting surface 20.

As illustrated in FIG. 6D, the fiber optic module 74 can be locked into place in the rails 56(1) by protrusions 88A, 88B provided in a latching system 90A, 90B disposed in the rail guides 82A, 82B, respectively. As illustrated in FIG. 6D, the protrusions 88A, 88B are each configured to be secured into notches 92A, 92B disposed in the rails 56(1) to lock the fiber optic module 74 about the rear stacker assemblies 58(1). When it is desired to release the fiber optic module 74 from the rear stacker assemblies 58(1), latches 94A, 94B can be pushed inward toward the fiber optic module 74 to release the protrusions 88A, 88B from the notches 92A, 92B, respectively, to allow the rail guides 82A, 82B of the fiber optic module 74 to be moved about the rails 56(1) of the rear stacker assemblies 58(1).

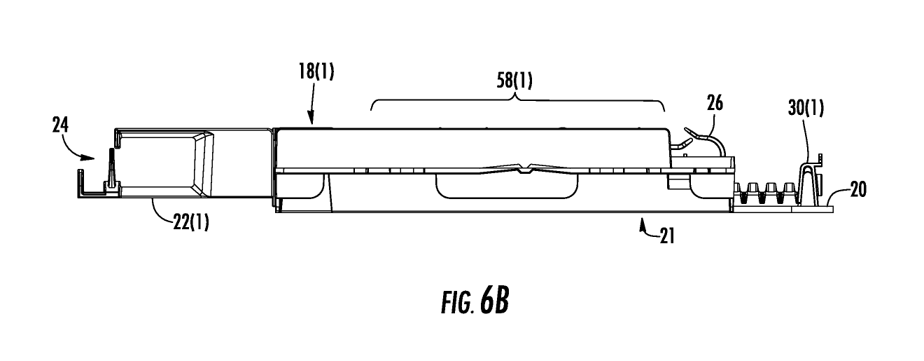

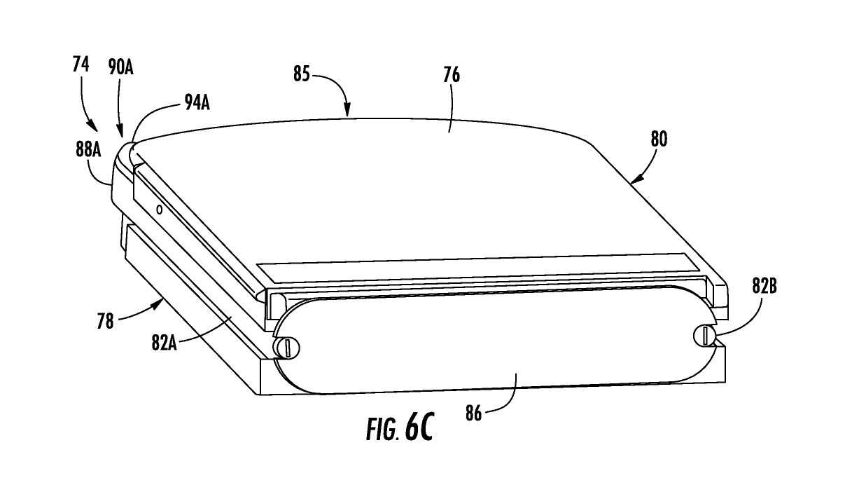

As previously discussed, providing the front stacker assemblies 18 and rear stacker assemblies 58 allows the stackable shelf 10 to be configured in a stacked arrangement to support fiber optic equipment at multiple height spaces as needed or desired. One example of this arrangement is illustrated in FIGS. 8A-8C. FIGS. 8A-8C are perspective, front, and rear views, respectively, of the stackable shelf 10 in FIGS. 1A-2D including additional front removable stacker assemblies 18(2) stacked on top of the front stacker assemblies 18(1) to support additional fiber optic panels 16(2) stacked over fiber optic panels 16(1) in a 2 U height space. FIG. 9 is a perspective view of the stackable shelf 10 in FIGS. 1A-2D including additional front removable stacker assemblies 18(2) stacked on top of the front stacker assemblies 18(1) to support an additional fiber optic panel 16(2) stacked over the fiber optic panel 16(1) and an additional fiber optic module 74(2) stacked over the fiber optic module 74(1) in a 2 U height space. FIG. 10 is a perspective view of the stackable shelf 10 in FIGS. 1A-2D including additional rear removable stacker assemblies 58(2) stacked on top of the rear stacker assemblies 58(1) to support additional fiber optic modules 74(2) stacked over the fiber optic modules 74(1) in a 2 U height space. Thus, in these configurations, the stackable shelf 10 is configured for providing fiber optic equipment in a 2 U height space for a 2 U fiber optic housing.

In FIGS. 8A-8C and 9, the removable panels clips 38(1), 38(2) previously described are employed to secure the fiber optic panels 16(1), 16(2) to the front stacker assemblies 18(1), 18(2), respectively. More information regarding stacking of front stacker assemblies 18 on top of other front stacker assemblies 18 to support additional fiber optic equipment at additional height spaces in the stackable shelf 10, such as front stacker assemblies 18(2) stacked on top of the front stacker assemblies 18(1) in FIGS. 8A-8C, is described below and illustrated in FIGS. 12A-12F.

FIG. 11 is a perspective view of the stackable shelf 10 in FIGS. 1A-2D including additional rear removable stacker assemblies 58(2) stacked on top of the rear stacker assemblies 58(1), and rear removable stacker assemblies 58(3) stacked on top of the rear stacker assemblies 58(2) to support additional fiber optic modules 74(3), 74(2) stacked over the fiber optic modules 74(1) in a 3 U height space. Thus, in this configuration, the stackable shelf 10 is configured for providing fiber optic equipment in 3 U height space for a 3 U fiber optic housing.

FIGS. 12A-12F are a perspective exploded, assembled perspective, front, side, top, and bottom views, respectively, of the front stacker assembly 18. The front stacker assembly 18 illustrated in FIGS. 12A-12F is shown as a removable stacker assembly 18 that can be attached and removed to the mounting surface 20 and/or on top of other front stacker assemblies 18. However, the design features in the front stacker assembly 18 illustrated in FIGS. 12A-12F could also be employed in a front stacker assembly 18 that is not removable and disposed permanently on the mounting surface 20 of the stackable shelf 10, as illustrated in FIG. 4.

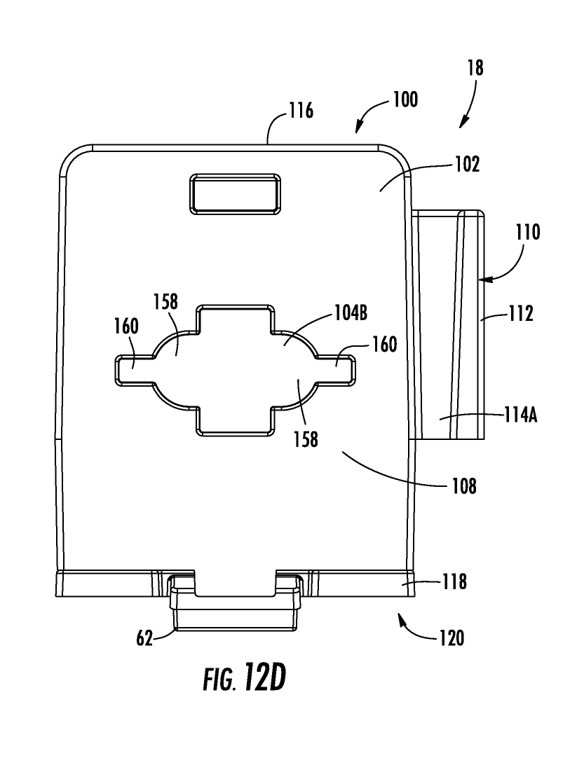

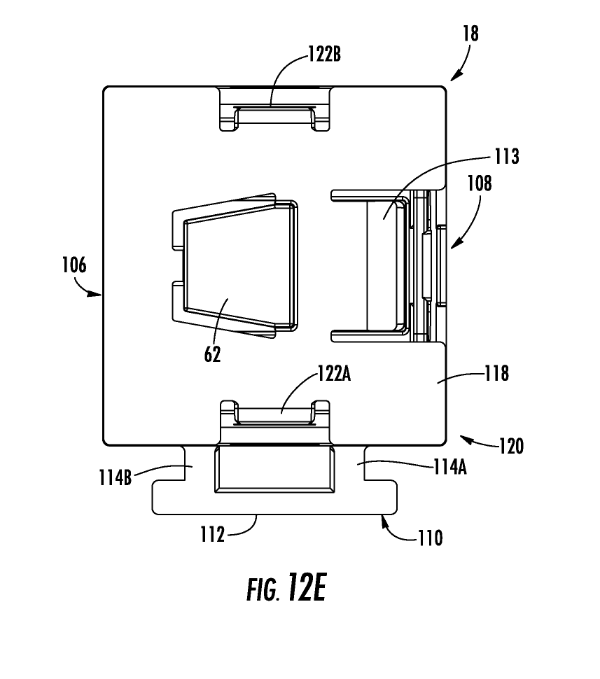

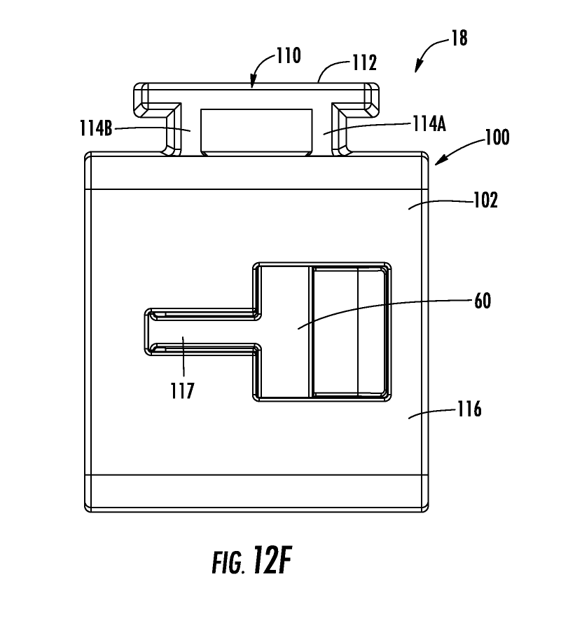

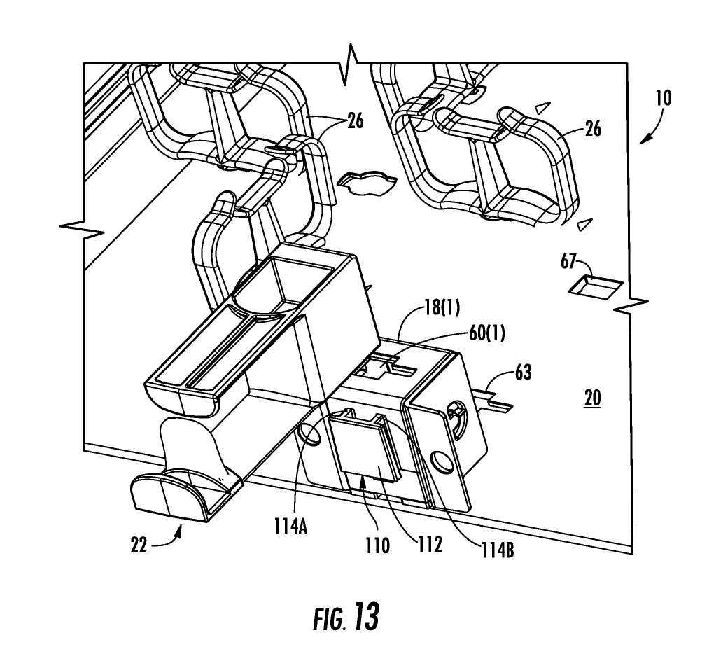

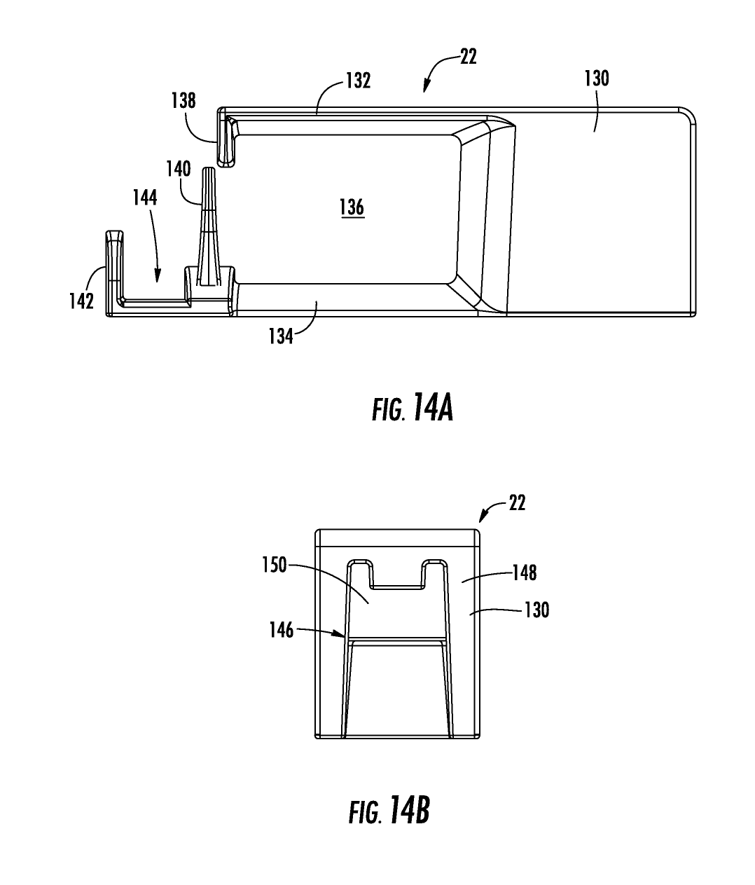

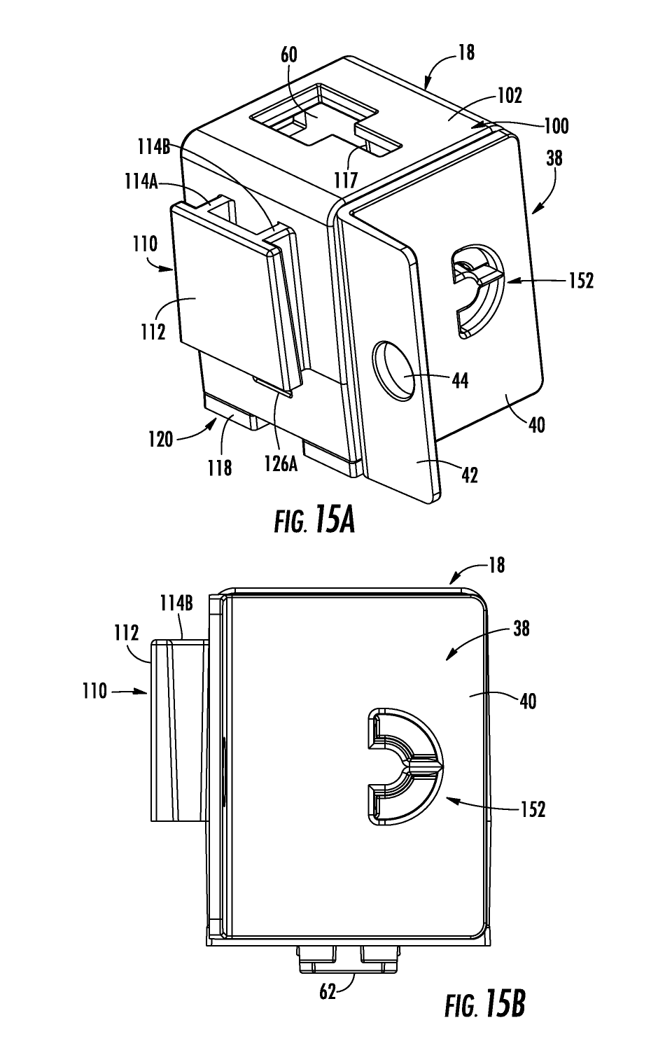

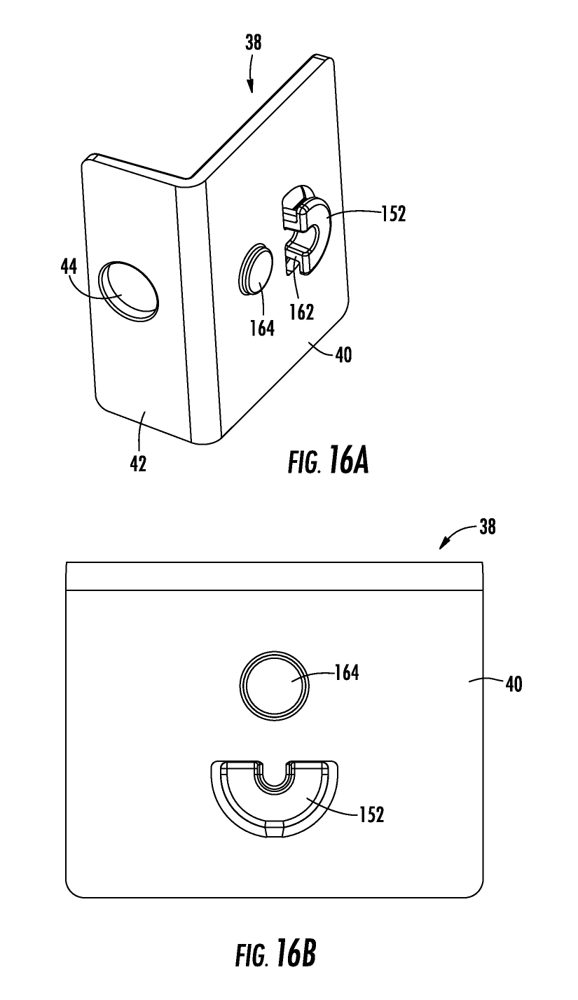

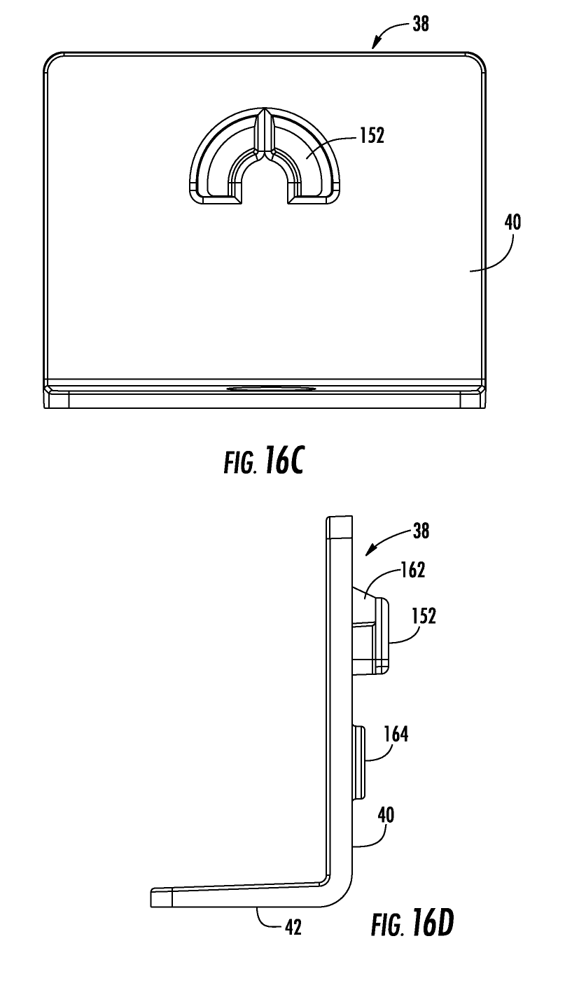

As illustrated FIGS. 12A-12F, the front stacker assembly 18 includes a support member 100. The support member 100 is comprised of a support body 102. The receiver 60 previously described with regard to FIGS. 4, 5B, and 5D is disposed in the support body 102. A first receiver 104A comprised of an opening in this embodiment is disposed in a first side 106 of the support body 102 and is configured to support fiber optic equipment in the stackable shelf 10. A second receiver 104B (FIG. 12D) comprised of a second opening in this embodiment is disposed in a second side 108 of the support body 102, and is also configured to support fiber optic equipment in the stackable shelf 10. For example, as previously discussed and discussed in more detail below with regard to FIGS. 15A-16E, the removable panel clips 38 can be attached to the first and second receivers 104A, 104B in the support body 102 so that fiber optic panels 16 can be secured to the removable panel clips 38. In turn, the fiber optic panels 16 attached to the removable panel clips 38 are then secured to the support body 102 of the front stacker assembly 18.

With continuing reference to FIGS. 12A-12F, a fiber routing guide receiver 110 is also disposed in the support body 102. The fiber routing guide receiver 110 is comprised of a platform 112 raised from the surface of the support body 102 by two (2) support members 114A, 114B. The fiber routing guide receiver 110, and more particularly, the platform 112, is configured to receive the front fiber routing guide 22, as described in more detail below and illustrated in FIGS. 13-14B.

With continuing reference to FIGS. 12A-12F, the receiver 60 previously discussed is disposed in a top side 116 of the support body 102. The receiver 60 contains a keyed portion 117. The receiver 60 is configured to receive the latch 62, previously described and illustrated in FIG. 5A, and illustrated in FIGS. 12C-12F. The latch 62 in this embodiment is disposed in an attachment body 118 of an attachment member 120 configured to receive the support body 102 as illustrated in FIG. 12A, and as assembled in FIG. 12B. To secure the latch 62 to the receiver 60, a locking feature 113 as illustrated in FIGS. 12C and 12E, is first inserted into the receiver 60 and slid underneath the receiver 60. As a result, the latch 62 is inserted into the receiver 60 and slid about the receiver 60 into the keyed portion 117 to be secured to the support body 102. In this scenario, the latch 62 can be disposed in the receiver 60 in the top side 116 of the support body 102 of the front stacker assembly 18 to allow one front stacker assembly 18 to be stacked on top of another front stacker assembly 18 to allow the stackable shelf 10 to be configured to support fiber optic equipment at additional height spaces above a 1-U height space, as desired or needed. This configuration also allows the front stacker assembly 18 to be secured to the mounting surface 20, as previously discussed with regard to FIG. 5A, wherein the latch 62 is disposed in the receiver 59 in the mounting surface 20 to support fiber optic equipment in the first 1-U height space from the mounting surface 20.

With reference to FIGS. 12A and 12B, the attachment body 118 is provided as a separate component configured to be secured to the support body 102. In this regard, latches 122A, 122B are disposed in the attachment body 118, as illustrated in FIG. 12A. The latches 122A, 122B contain extension members 124A, 124B that are configured to be bent inward as the support body 102 is disposed over top the attachment body 118. The energy stored in the extension members 124A, 124B will eventually cause the extension members 124A, 124B to extend outward into openings 126A, 126B to secure the support body 102 to the attachment body 118, as illustrated in FIG. 12B.

FIG. 13 is a perspective view of the exemplary front fiber routing guide 22 in FIGS. 1A-2D positioned to be secured to the front stacker assembly 18 in FIGS. 12A-12F installed in the stackable shelf 10 of FIG. 4. More particularly, the front fiber routing guide 22 is configured to be secured to the fiber routing guide receiver 110 comprised of the platform 112 raised from the surface of the support body 102 by the support members 114A, 114B, as illustrated in FIGS. 12A-12F and described above. Although not illustrated in FIG. 13, the fiber routing guide receiver 110 is also configured to receive and secure the elongated fiber routing guides 34 illustrated in FIGS. 3A and 3B.

FIGS. 14A and 14B are side and rear views, respectively, of the front fiber routing guide 22 that is configured to be attached to the front stacker assembly 18 illustrated in FIG. 13. As illustrated in FIG. 14A, the front fiber routing guide 22 is comprised of a routing guide body 130. Two (2) extension members 132, 134 extend from the routing guide body 130 such that a retention area 136 is created therebetween for optical fibers to be retained. The extension member 132 contains an end extension 138 and the extension member 134 contains a retainer 140, respectively, to retain optical fibers in the retention area 136. The end extension 138 and the retainer 140, for example a flap, are not closed so that optical fibers can be disposed therebetween into the retention area 136. An additional extension member 142 is also provided to allow the stackable shelf 10 to be pulled out with an additional area 144 to provide for finger access.

To attach the front fiber routing guide 22 to the platform 112 on the front stacker assembly 18 as illustrated in FIG. 13, a receiver 146 is disposed in a rear side 148 of the front fiber routing guide 22, as illustrated in FIG. 14B. The receiver 146 is comprised of a hood 150 that is configured to be slipped over a top portion of the platform 112 of the fiber routing guide receiver 110. The front fiber routing guide 22 can be removed from the front stacker assembly 18 by pulling up on the front fiber routing guide 22 such that the hood 150 is lifted off of the platform 112 of the fiber routing guide receiver 110 to clear the front fiber routing guide 22 from the front stacker assembly 18.

As previously discussed with regard to FIG. 3A, the front stacker assembly 18 is also configured to support the removable panel clip 38 to allow fiber optic panels 16 to be secured to the front stacker assembly 18 and thus supported by the stackable shelf 10. The removable panel clip 38 allows fiber optic panels 16 and fiber optic modules 74 to be supported interchangeably in the stacked shelf 10 in this embodiment. In this regard, FIGS. 15A and 15B are perspective and side views, respectively, of the front stacker assembly 18 in FIGS. 12A-12F with the removable panel clip 38 secured thereto to support securing fiber optic panels 16 to the stackable shelf 10 in FIG. 4.

As illustrated in FIGS. 15A-16E, the removable panel clip 38 includes a flange 152. The flange 152 is configured to be inserted into the receiver 104A or 104B of the front stacker assembly 18 (FIGS. 12A and 12D) to attach the removable panel clip 38 to the front stacker assembly 18. The flange 152 in this embodiment is arcuate-shaped, but other shapes can be provided, including but not limited to semi-circular and circular. The flange 152 is disposed in the first surface 40 of the removable panel clip 38 (see also FIGS. 2A-2C). The receiver 44 disposed in the second surface 42 to the first surface 40 of the removable panel clip 38 is configured to receive the insert 46 of a fiber optic panel 16, as illustrated in FIGS. 2A-2C. The first surface 40 is orthogonal to the second surface 42 in this embodiment. The flange 152 is configured to be inserted in a first area 158 of the receiver 104A or 104B and slid into a second area 160 of the receiver 104A or 104B, as illustrated in FIG. 12D, to attach the removable panel clip 38 to the front stacker assembly 18. A standoff or extender 162 (FIG. 16A) is disposed between the flange 152 and the first surface 40 to extend the flange 152 a distance away from the first surface 40 so the flange 152 can be inserted into the receiver 104A or 104B in the front stacker assembly 18. The flange 152 can then be slid behind the second area 160 of the receiver 104A or 104B, which has an opening size less than the size of the flange 152.

The flange 152 cannot be removed from the receiver 104A or 104B unless and until the flange 152 is slid back to the first area 158 of the receiver 104A or 104B, which has an opening size that will allow the flange 152 to be removed from the receiver 104A or 104B. A protrusion 164 is also disposed in the first surface 40 of the removable panel clip 38 to be disposed into the second area 160 of the receiver 104A or 104B to further secure the removable panel clip to the removable stacker assembly 18.

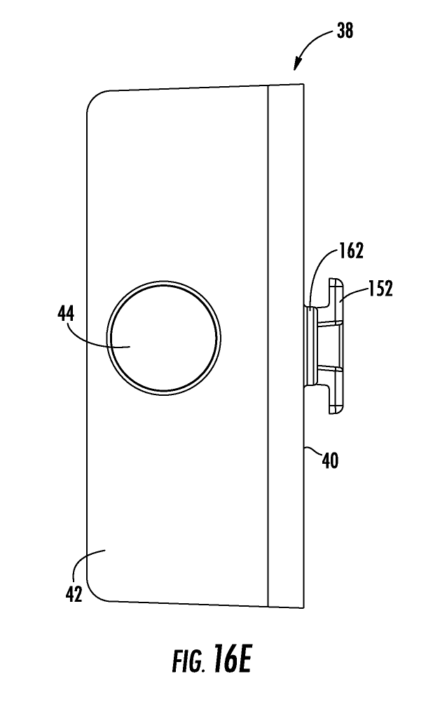

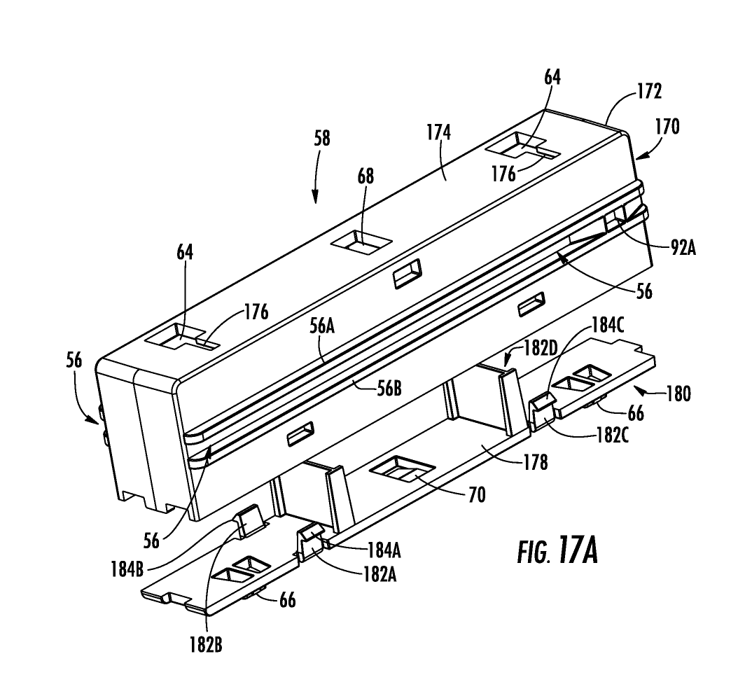

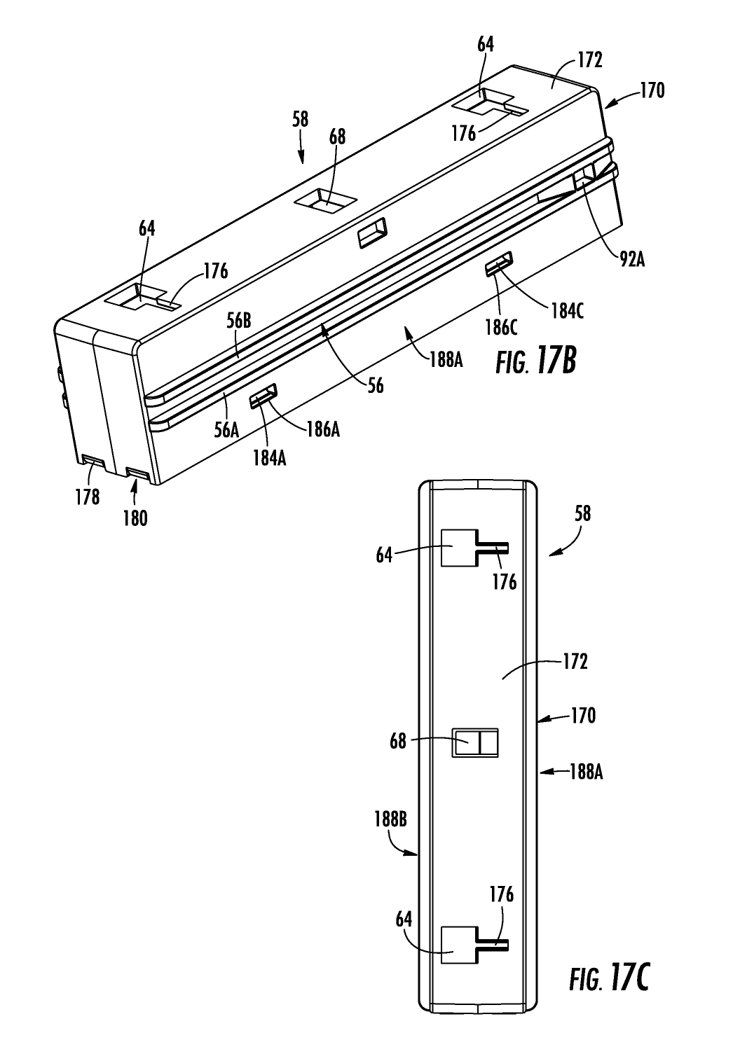

FIGS. 17A-17F are exploded perspective, assembled perspective, top, side, front, and bottom views, respectively, of the rear stacker assembly 58. The rear stacker assembly 58 illustrated in FIGS. 17A-17F is shown as a removable rear stacker assembly 58 that can be attached to and removed from the mounting surface 20 and/or on top of other rear stacker assemblies 58. However, the design features in the rear stacker assembly 58 illustrated in FIGS. 17A-17F could also be employed in a rear stacker assembly 58 that is not removable and disposed permanently on the mounting surface 20 of the stackable shelf 10, as illustrated in FIG. 4.

As illustrated FIGS. 17A-17F, the rear stacker assembly 58 includes a support member 170. The support member 170 is comprised of a support body 172. The receivers 64, 67 in the form of openings in this embodiment and previously described with regard to FIGS. 5A-5D are disposed in the support body 172. The receivers 64, 67 are disposed in a top side 174 of the support body 172. As illustrated in FIGS. 17A-17C, the receivers 64 contain keyed portions 176. The receivers 64, 67 are configured to receive the latches 66, 70, respectively, previously described and illustrated in FIGS. 5A-5D, and illustrated in FIGS. 17A and 17D-17E. The latches 66, 70 in this embodiment are disposed in an attachment body 178 of an attachment member 180 configured to receive the support body 172 as illustrated in FIG. 17A, and as assembled in FIG. 17B. The latches 66 are inserted into the receivers 64 and slid about the receivers 64 into the keyed portions 176 to be secured to the support body 172. In this scenario, the latches 66 can be disposed in the receivers 64 in the top side 174 of the support body 172 to allow one rear stacker assembly 58 to be stacked on top of another rear stacker assembly 58 to allow the stackable shelf 10 to be configured to support fiber optic equipment at additional height spaces about a 1-U height space, as desired or needed. This configuration also allows the rear stacker assembly 58 to be secured to the mounting surface 20, as previously discussed with regard to FIG. 5C, wherein the latches 66 are disposed in the receivers 63 in the mounting surface 20 to support fiber optic equipment in the first 1-U height space from the mounting surface 20.

With reference to FIGS. 17A and 17B, the attachment body 178 is provided as a separate component configured to be secured to the support body 172. In this regard, latches 182A-182D are disposed in the attachment body 178, as illustrated in FIG. 17A. The latches 182A-182D contain protrusion members 184A-184D that are configured to be bent inward as the support body 172 is disposed over top the attachment body 178. The protrusion members 184A-184D are resilient such that they provide biasing, thus eventually causing the extension members 184A-184D to extend outward into openings 186A-186D to secure the support body 172 to the attachment body 178, as illustrated in FIG. 17B.

As previously discussed with regard to FIGS. 6A-6D, and as illustrated in FIGS. 12A-12F, rails 56 disposed on each side 188A, 188B in the rear stacker assembly 58 are configured to receive the rail guides 82A, 82B disposed in the housing 76 the fiber optic module 74 to support the fiber optic module 74 between two (2) adjacent rear stacker assemblies 58. In this embodiment of the rear stacker assembly 58, the rails 56 are comprised of two sub-rails 56A, 56B, whose combined width is configured to be received inside the rail guides 82A, 82B of the fiber optic module 74. A solid rail could alternatively be employed as the rail 56. Employing the sub-rails 56A, 56B reduces material and weight of the rear stacker assemblies 58.

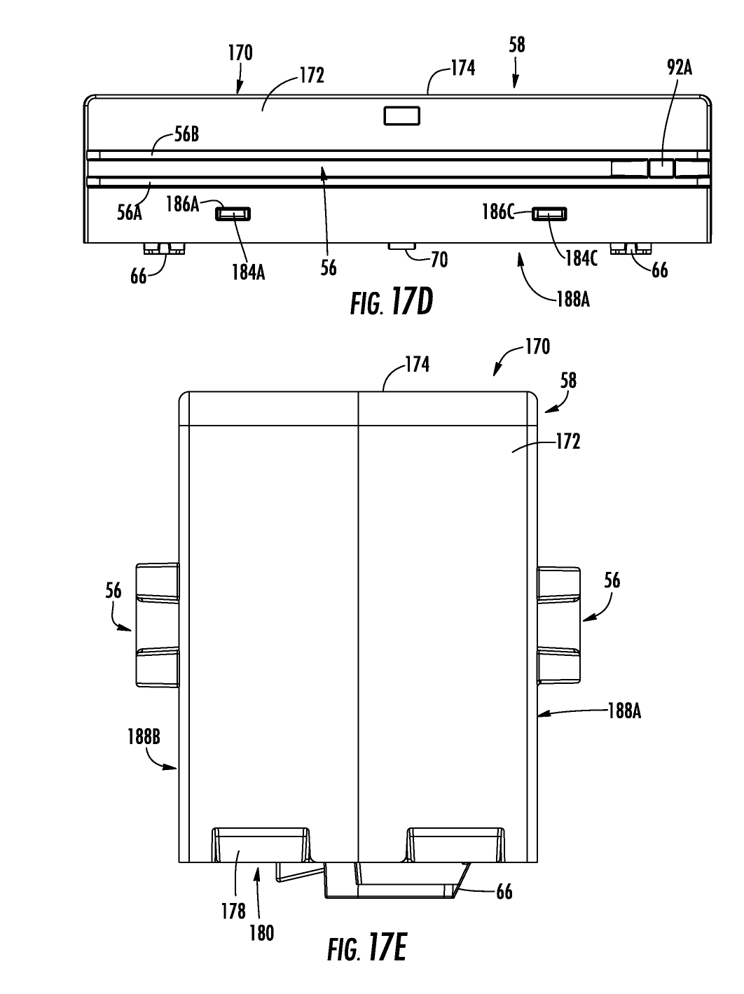

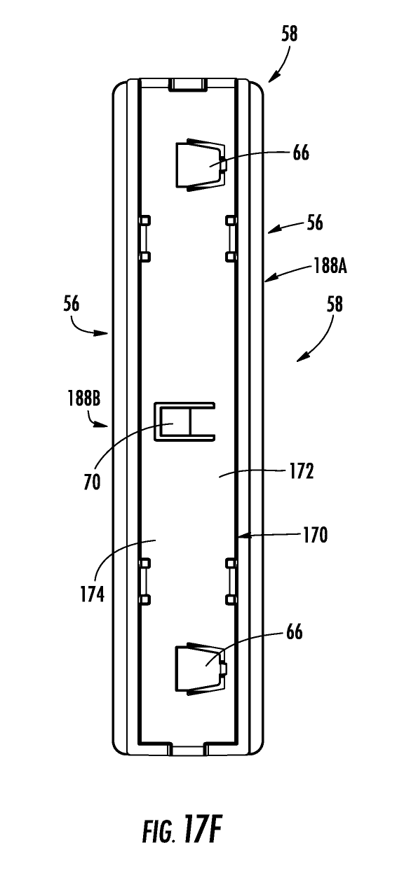

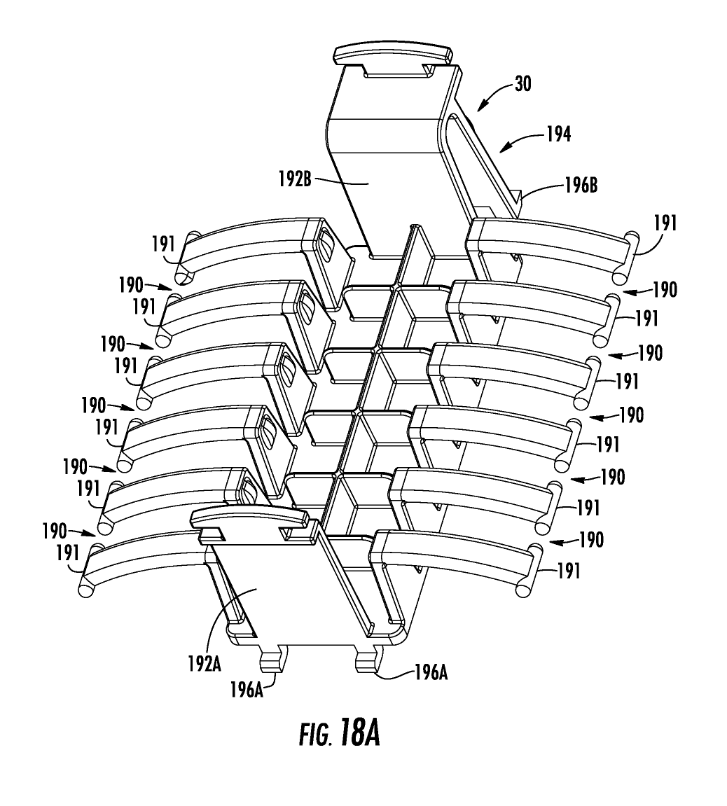

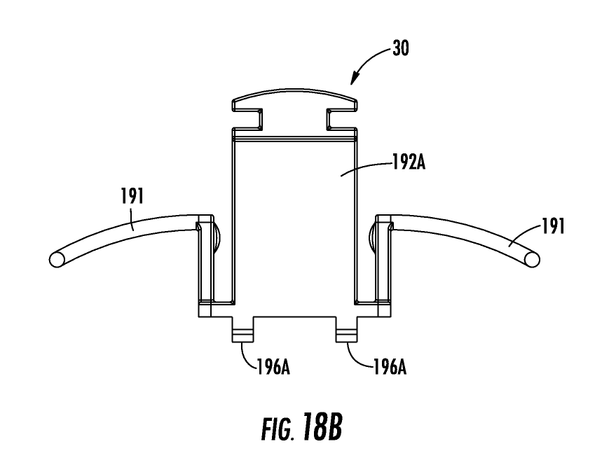

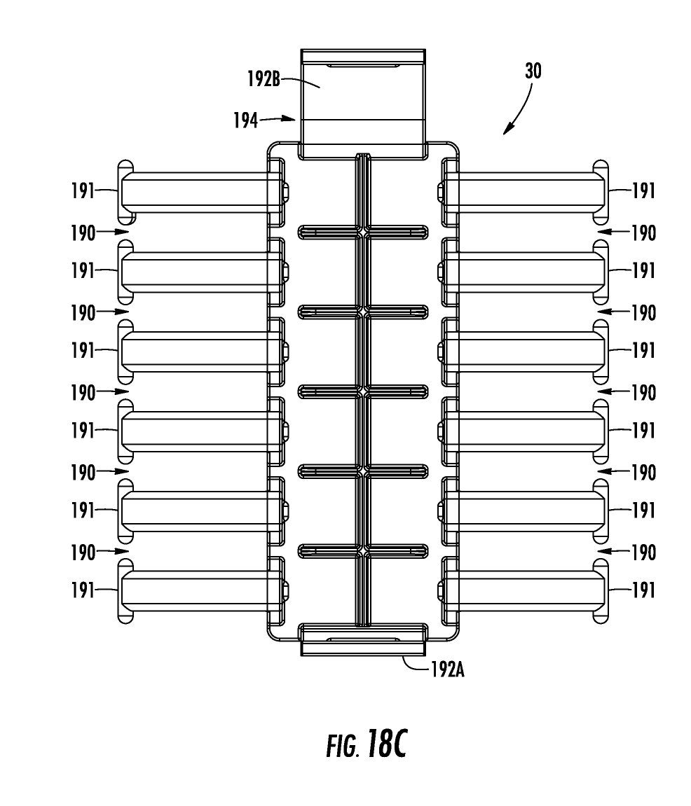

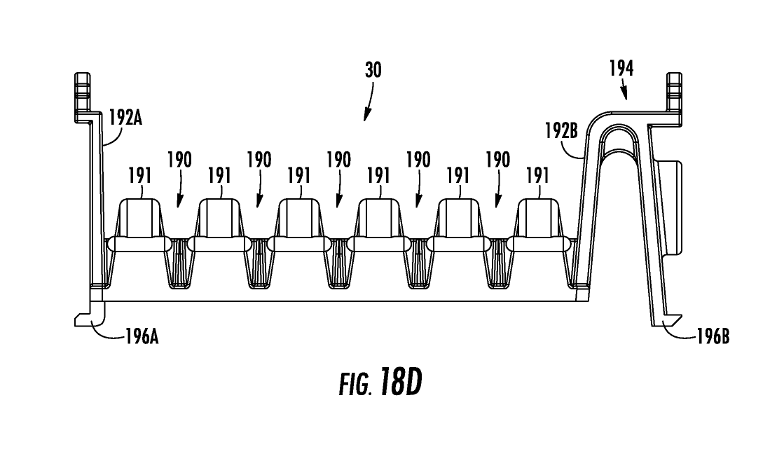

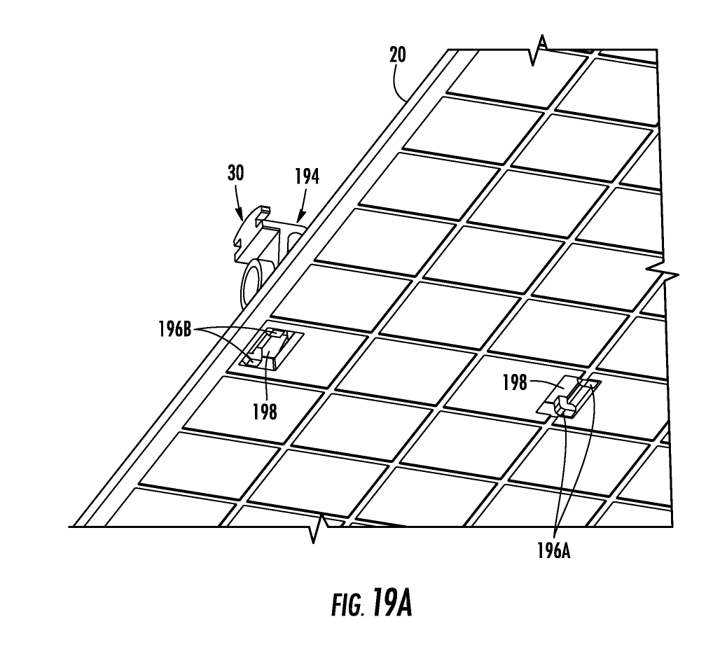

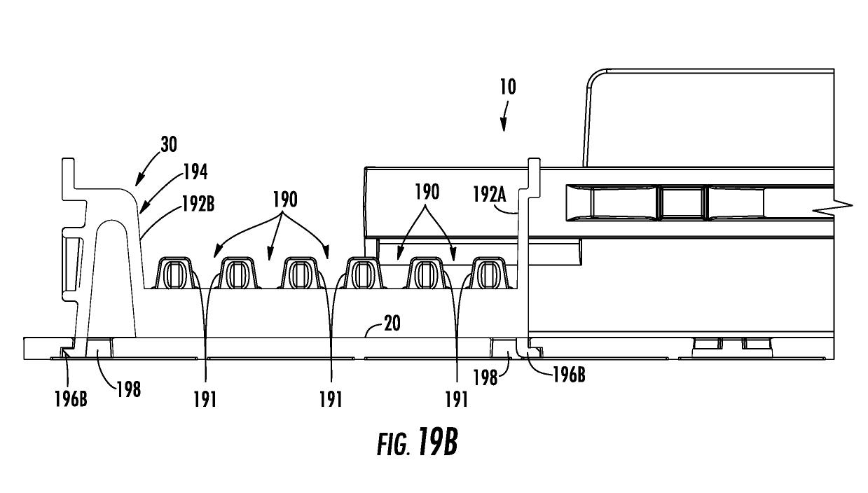

FIGS. 18A-18D are perspective, front, top, and side views, respectively, of the fiber body holder 30 disposed in the stackable shelf 10 in FIG. 1A-2D. As previously discussed and illustrated in FIG. 2D, the fiber body holder 30 is configured to hold and support the fiber furcation bodies 32 disposed in the stackable shelf 10. The fiber body holder 30 contains a plurality of channels 190 disposed between extension members 191. Each of the plurality of channels 190 is configured to support a fiber body holder 30 disposed therein. End sections 192A, 192B provide for the ability of a technician to grip the fiber body holder 30 and to squeeze a latch 194 so that protrusion members 196A, 196B can be inserted into receivers 198 (FIG. 19A) disposed in the mounting surface 20 to secure the fiber body holder 30 to the mounting surface 20. This is illustrated in the perspective bottom view of the mounting surface 20 in FIG. 19A and the side view of the mounting surface 20 in FIG. 19C to secure the fiber body holder 30 to the mounting surface 20. If additional capacity is needed or desired to support additional fiber bodies 32, an additional fiber body holder 30(2) can be provided and stacked on top of the fiber body holder 30(1) secured to the mounting surface 20 of the stackable shelf 10, as illustrated in FIG. 20.

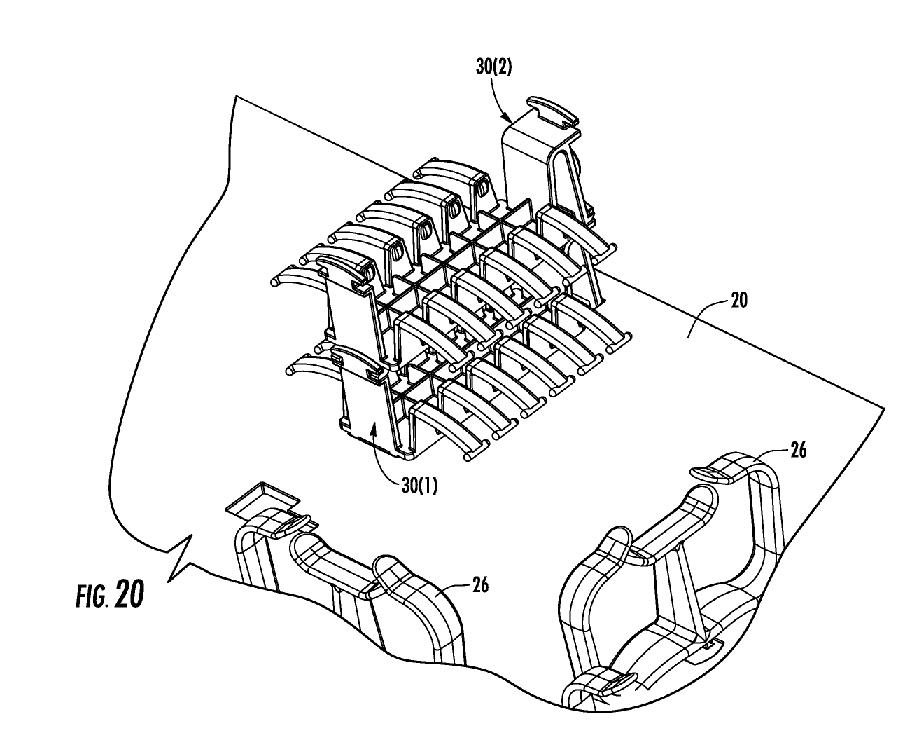

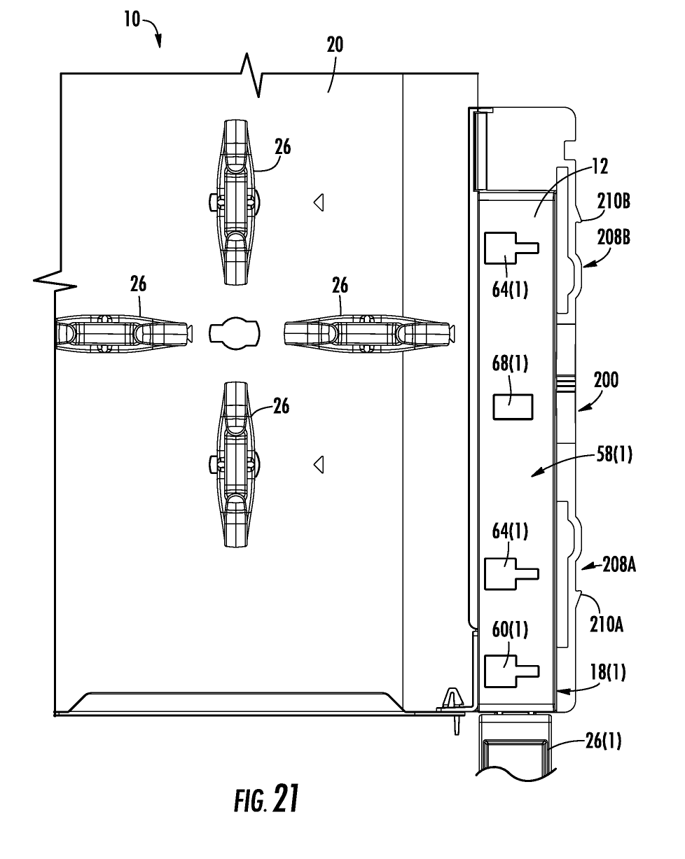

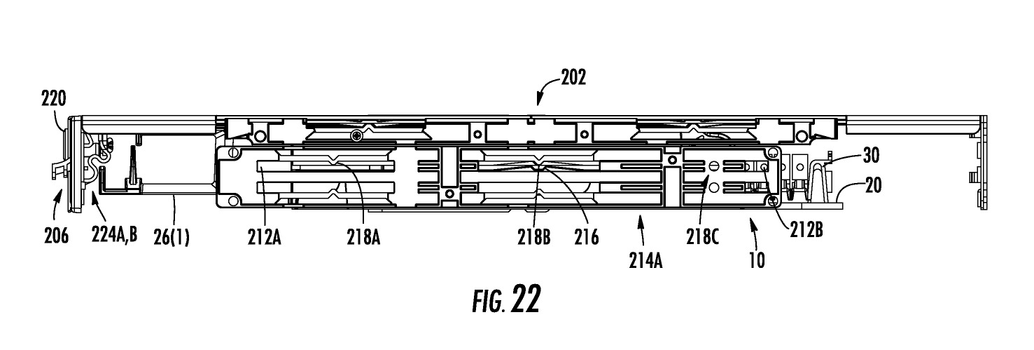

Once the stackable shelf 10 is configured with the desired fiber optic equipment, the stackable shelf 10 is configured to be inserted into a fiber optic housing. The fiber optic housing containing the stackable shelf 10 can then be mounted in an equipment rack. In this regard, FIG. 21 is a top close-up view of the right side of the stackable shelf 10 illustrating an exemplary rail system 200 configured to allow the stackable shelf 10 to be movable about and secured within a 1-U fiber optic housing 202, as illustrated in FIGS. 22-24. A rail system like that of the exemplary rail system 200 is also disclosed in U.S. patent application Ser. No. 12/576,806 entitled “Fiber Optic Equipment Guides and Rails Configured With Stopping Position(s), and Related Equipment and Methods,” the disclosure of which is relied upon and incorporated herein by reference in its entirety.

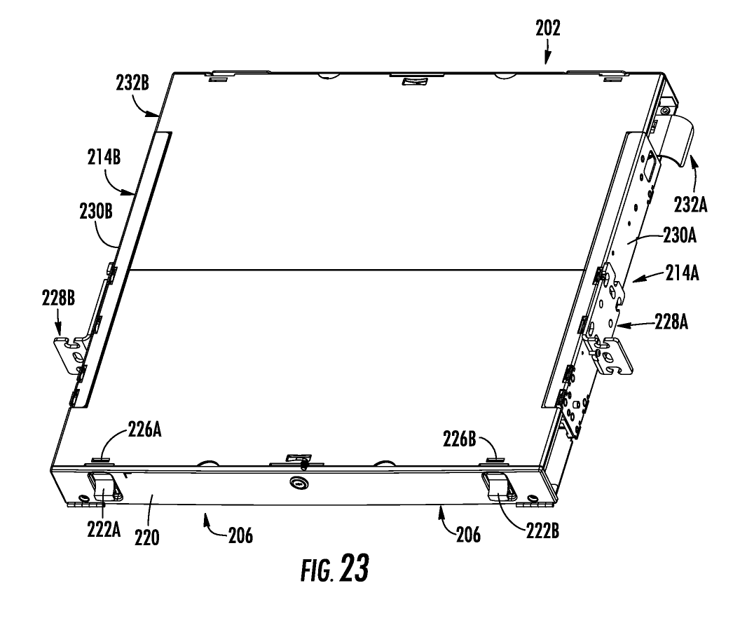

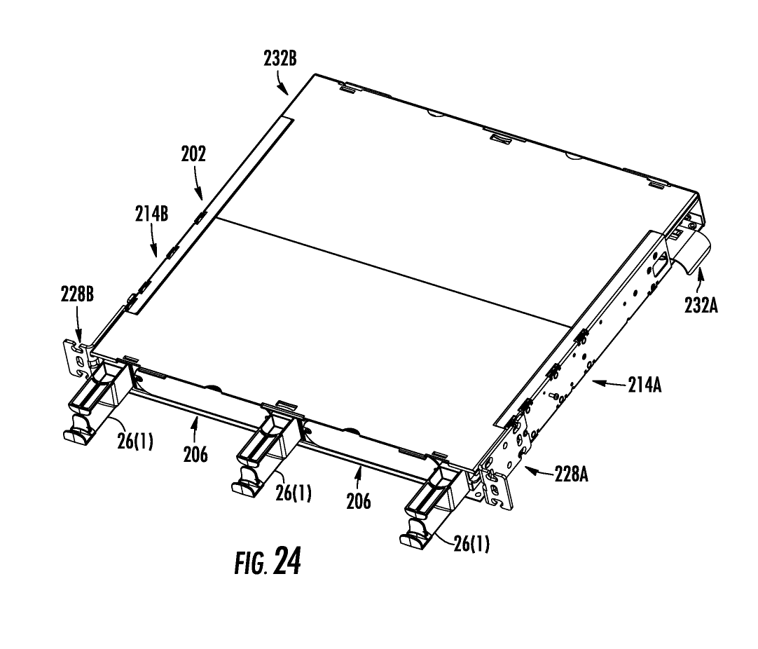

FIG. 22 is a side view of the right side, transparent view of the stackable shelf 10 of FIGS. 1A-2D installed inside the fiber optic housing 202. FIG. 23 is a perspective view of the fiber optic housing 202 that includes the stackable shelf 10 in FIG. 22 with mounting brackets 228A, 228B installed in a rear position of the fiber optic housing 202 wherein the front fiber routing guides 22(1) do not extend beyond a front 206 of the fiber optic housing 202. FIG. 24 is a perspective view of the fiber optic housing 202 that includes the stackable shelf 10 in FIG. 22 with mounting brackets 204A, 204B installed in a front position on the fiber optic housing 202, wherein the front fiber routing guides 22(1) extend beyond the front 206 of the fiber optic housing 202.

As illustrated in FIG. 21, the rail system 200 contains two leaf springs 208A, 208B. The leaf springs 208A, 208B contain protrusions 210A, 210B that are configured to engage with stops 212A, 212B inside sides 214A, 214B of the fiber optic housing 202, as illustrated in FIGS. 21 and 22. The stops 212A, 212B prevent the stackable shelf 10 from being removed from the fiber optic housing 202 unless enough force is applied to the stackable shelf 10 to bend the leaf springs 208A, 208B to allow the protrusions 210A, 210B to clear the stops 212A, 212B. As illustrated in FIG. 22, a detent 216 disposed in the rail system 200 of the stackable shelf 10 is configured to receive protrusions 218A-218C. The protrusions 218A-218C provide stopping positions for the stackable shelf 10 to be moved in and out of the fiber optic housing 202 for access and storage without having to fully remove the stackable shelf 10 from the fiber optic housing 202.

As illustrated in FIGS. 22 and 23, the fiber optic housing 202 may be configured with a door 220 that can be closed to secure the stackable shelf 10 inside the fiber optic housing 202. Release latches 222A, 222B are provided in the door 220 to allow the door 220 to be opened when the release latches 222A, 222B are engaged downward to release locks 224A, 224B from openings 226A, 226B. Mounting brackets 228A, 228B are installed on the sides 214A, 214B of the fiber optic housing 202, respectively, to allow the fiber optic housing 202 to be mounted in an equipment rack. The fiber optic housing 202 contains mounting receivers 230A, 230B that allow the mounting brackets 228A, 228B to be positioned behind the front 206 of the fiber optic housing 202, as illustrated in FIG. 23, or at the front 206 of the fiber optic housing 202, as illustrated in FIG. 24. Strain relief brackets 232A, 232B are provided to relieve strain from optic fibers routed to the fiber optic housing 202.

FIG. 25 includes perspective views of exemplary components used to provide a stackable shelf 10 supporting fiber optic equipment in the fiber optic housing 202. Previous elements already described are shown with common element numbers and are not re-described. The fiber optic housing 202 in this embodiment is comprised of a base 234, a cover 236 attached to the base 234, a rear section 238, and the door 220.

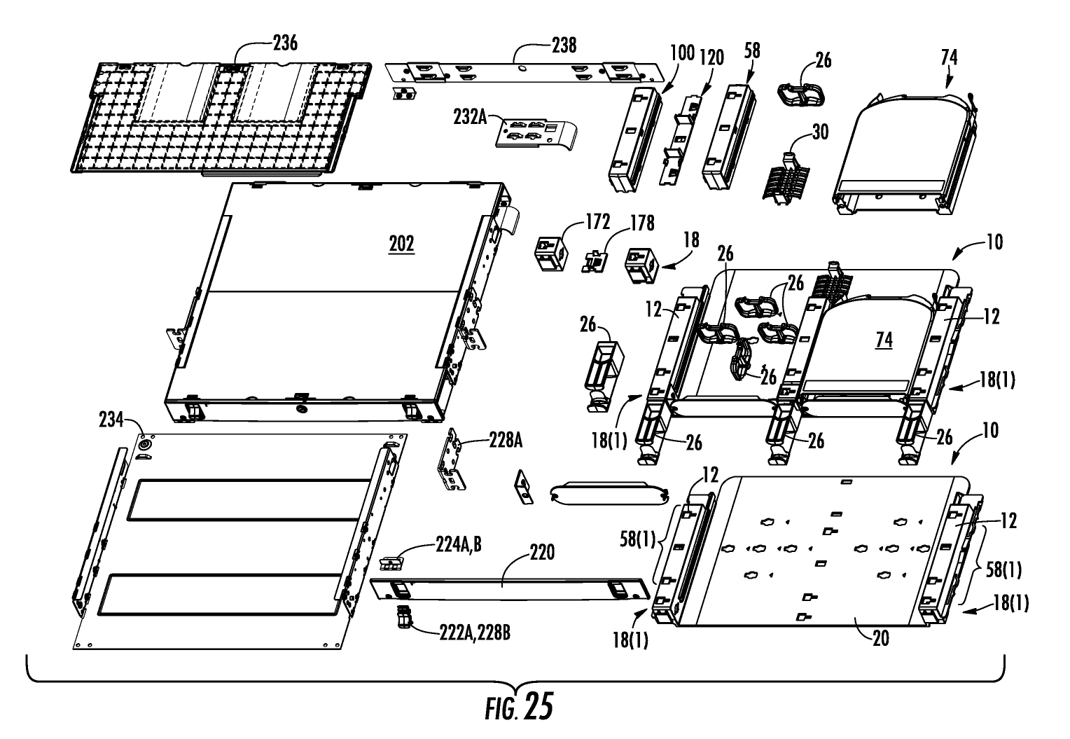

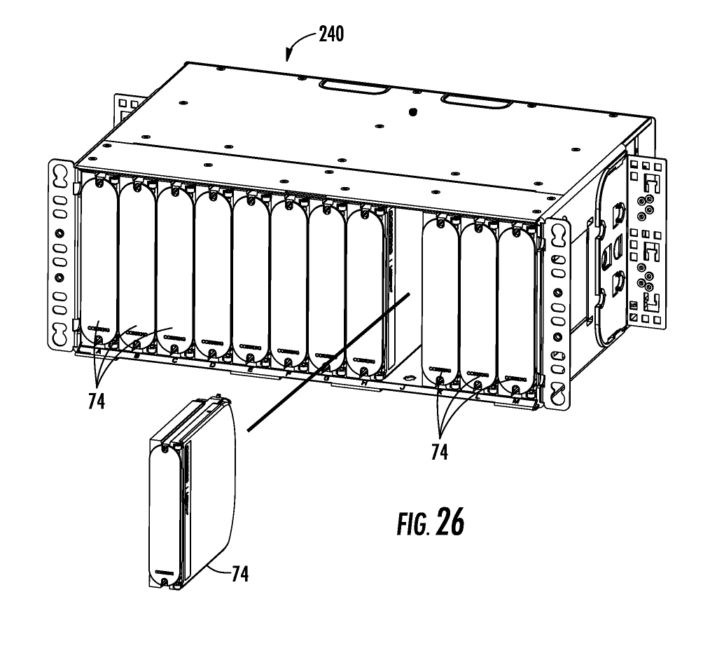

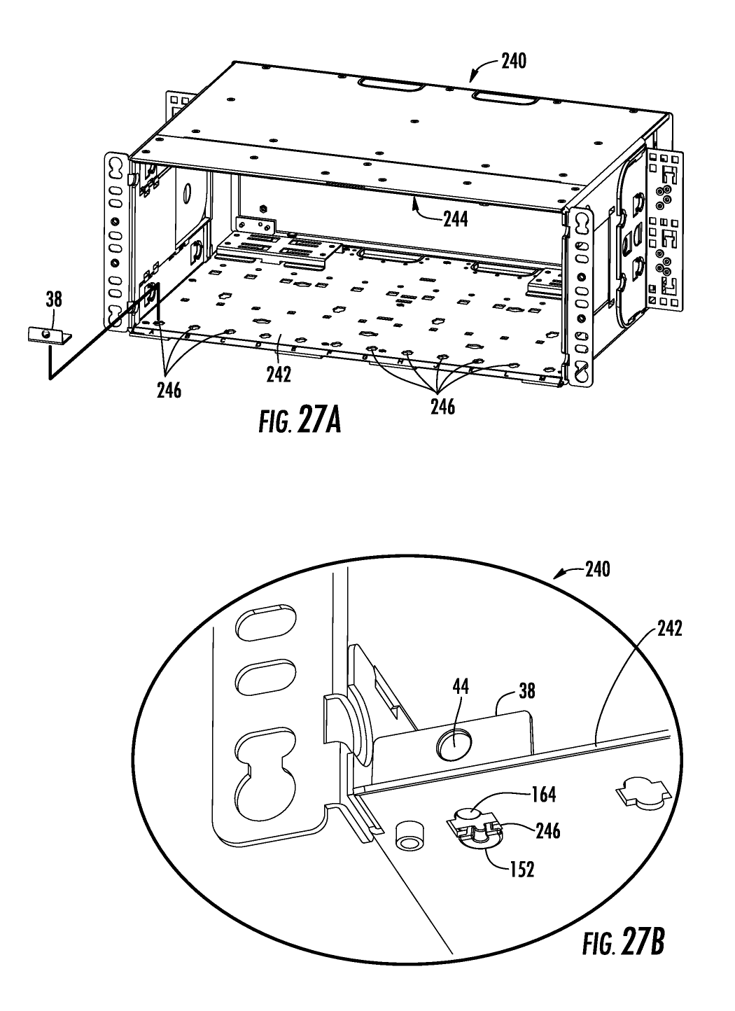

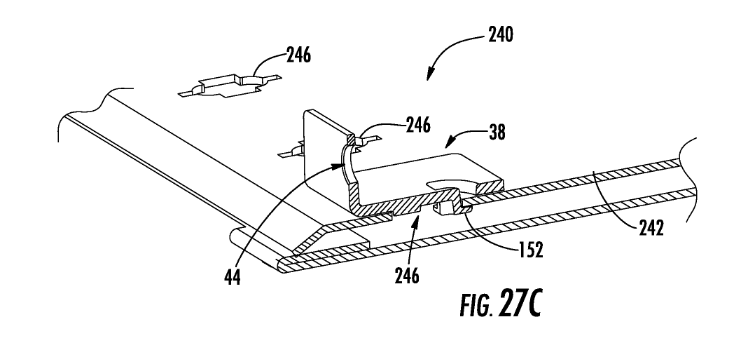

FIG. 26 is a perspective view of an alternative fiber optic housing 240 configured to support the fiber optic modules 74 and fiber optic panels 16 interchangably by employing the removable panel clip 38. However, the fiber optic housing 240 is configured to support fiber optic equipment in a vertical orientation as opposed to a horizontal orientation as provided in the fiber optic housing 202 in FIGS. 22-24. FIG. 26 illustrates the fiber optic housing 240 supporting the fiber optic modules 74. If it is desired to provide fiber optic panels 16 in the fiber optic housing 240, the removable panel clips 38 can be installed in a base 242 and a top 244 of the fiber optic housing 240, as illustrated in FIGS. 27A-27C. FIGS. 27A-27C are perspective, perspective close-up, and perspective close-up cut section views, respectively, of the removable panel clip 38 installed in the fiber optic housing 240 to enable the fiber optic housing 240 to support fiber optic panels 16 and fiber optic modules 74 interchangably. The base 242 contains receivers 246 in the form of openings that contain the same form as the receivers 104A, 104B in the front stacker assembly 18 in FIGS. 12A-12F to receive and secure the flange 152 of the removable panel clip 38. The removable panel clip 38 is secured to the receiver 246 in the base 242 in the same manner as the removable panel clip 38 is secured to the receiver 104A, 104B of the front stacker assembly 18 as previously described and illustrated in FIGS. 15A-16E, and thus is not be re-described herein.

FIG. 28A is a perspective view of the fiber optic housing in FIG. 27A with the removable panel clips 38 installed in the base 242 and the top 244 to be able support fiber optic panels 16. FIG. 28B is a perspective view of the fiber optic housing 240 in FIG. 27A with the removable panel clips 30 installed and the inserts 46 of the fiber optic panels 16 inserted into the receivers 44 of the removable panel clips 38 to support the fiber optic panels 16 in the fiber optic housing 240.

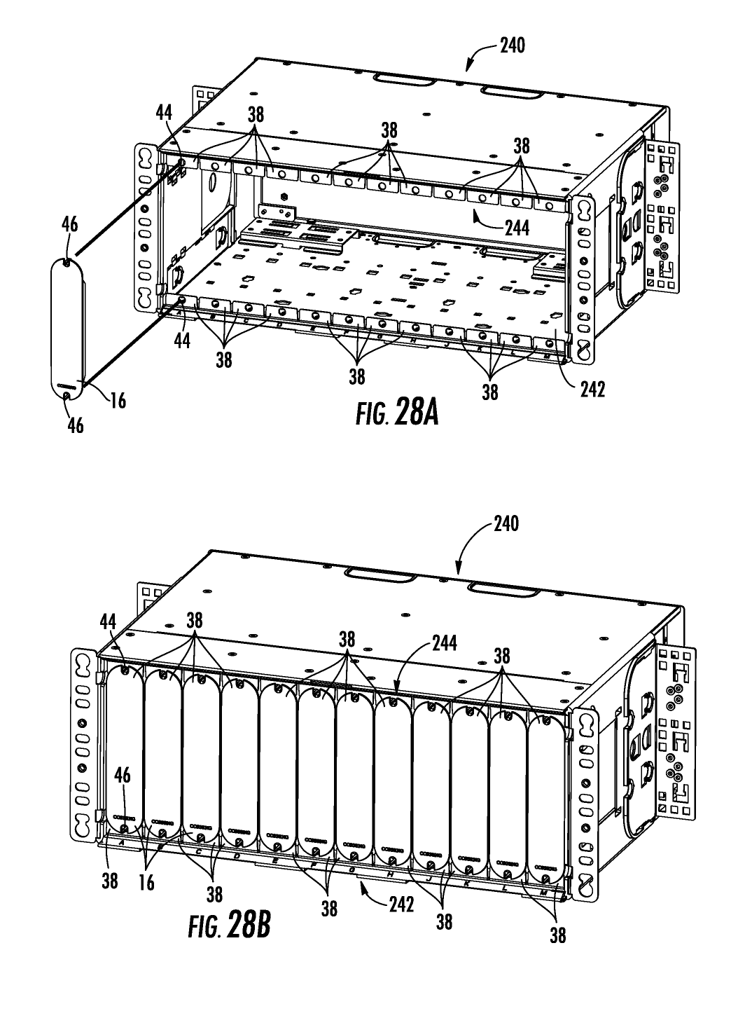

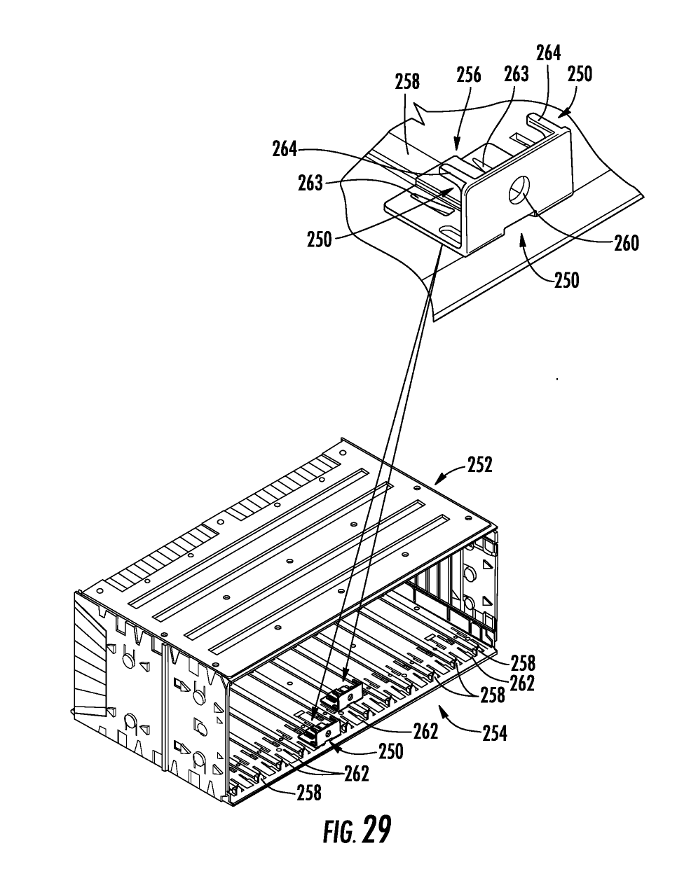

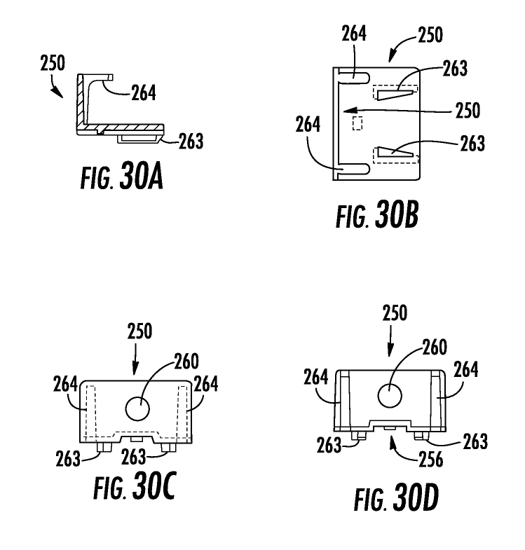

FIG. 29 is a perspective view of another alternative exemplary removable panel clip 250 installed in another alternative fiber optic housing 252 to enable the fiber optic housing 252 to interchangeably support fiber optic panels and fiber optic modules. FIGS. 30A-30D illustrate bottom, side, front, and back side views, respectively, of the removable panel clip 250 in FIG. 29. The removable panel clips 250 are configured to be attached to a rail system 254 disposed in the fiber optic housing 252 to attach the removable panel clips 250 to the fiber optic housing 252 to support fiber optic panels. The rail system 254 is configured to support fiber optic modules in the fiber optic housing 252 when the removable panel clip 250 is not attached to the rail system 254. In this regard, the removable panel clips 250 each comprise an opening 256 configured to receive a rail 258 disposed in the fiber optic housing 252 to attach the removable panel clips 250 to the fiber optic housing 252. Like the removable panel clip 38, the removable panel clip 250 contains a receptacle 260 disposed therein that is configured to receive an insert from a fiber optic panel to secure the fiber optic panel to the removable panel clip 250 and thus the fiber optic housing 252. Protrusions 263 are disposed in the removable panel clip 252, as illustrated in FIG. 29, that are configured to engage with receivers 262 to further secure the removable panel clips 250 to the fiber optic housing 252. A support member 264 is disposed or provided as part of the removable panel clip 250 to provide structural support, as illustrated in FIGS. 30A and 30B.

FIGS. 31A-1 and 31A-2 are top perspective views of first and second front stacker assembly components 270, 272, respectively, that are configured to be assembled together to form an alternative assembled front stacker assembly that can be installed in a stackable shelf, including but not limited to the stackable shelf 10, to support fiber optic equipment, including but not limited to fiber optic panels and fiber optic modules. In this regard, the first front stacker assembly component 270 is configured to fit and be secured to the second front stacker assembly component 272 to provide an assembled front stacker assembly. The second front stacker assembly component 272 contains protrusions 274 that are configured to fit inside and be secured to openings 276 in the first front stacker component 270. The assembled front stacker assembly can be secured to a mounting surface of a stackable shelf and fiber optic equipment secured thereto to support fiber optic equipment on a mounting surface.

FIGS. 31B-1 and 31B-2 are bottom perspective views of the front stacker assembly components 270, 272 in FIGS. 31A-1 and 31A-2, respectively, that are configured to be assembled together to form an alternative assembled front stacker assembly that can be installed in a stackable shelf to support fiber optic equipment. FIGS. 31C-1 and 31C-2 are first side views of the front stacker assembly components 270, 272 in FIGS. 31A-1 and 31A-2, respectively, that are configured to be assembled together to form an alternative assembled front stacker assembly that can be installed in a stackable shelf to support fiber optic equipment. FIGS. 31D-1 and 31D-2 are second side views of the front stacker assembly components 270, 272 in FIGS. 31A-1 and 31A-2, respectively, that are configured to be assembled together to form an alternative assembled front stacker assembly that can be installed in a stackable shelf to support fiber optic equipment. FIGS. 31E-1 and 31E-2 are bottom views of the front stacker assembly components 270, 272 in FIGS. 31A-1 and 31A-2, respectively, that are configured to be assembled together to form an alternative assembled front stacker assembly that can be installed in a stackable shelf to support fiber optic equipment. FIGS. 31F-1 and 31F-2 are top views of the front stacker assembly components 270, 272 in FIGS. 31A-1 and 31A-2, respectively, that are configured to be assembled together to form an alternative assembled front stacker assembly that can be installed in a stackable shelf to support fiber optic equipment.

FIGS. 32A-1 and 32A-2 are top perspective views of first and second rear stacker assembly components 280, 282, respectively, that are configured to be assembled together to form an alternative assembled rear stacker assembly that can be installed in a stackable shelf, including but not limited to the stackable shelf 10, to support fiber optic equipment, including but not limited to fiber optic panels, fiber optic modules, and fiber optic cassettes. In this regard, the first rear stacker assembly component 280 is configured to fit and be secured to the second rear stacker assembly component 282 to provide an assembled rear stacker assembly. The first rear stacker component 280 contains protrusions 284 that are configured to fit inside and be secured to openings 286 in the second rear stacker component 282. The assembled rear stacker assembly can be secured to a mounting surface of a stackable shelf and fiber optic equipment secured thereto to support fiber optic equipment on a mounting surface.

FIGS. 32B-1 and 32B-2 are first side views of the rear stacker assembly components 280, 282 in FIGS. 32A-1 and 32A-2, respectively, that are configured to be assembled together to form an alternative assembled rear stacker assembly that can be installed in a stackable shelf to support fiber optic equipment. FIGS. 32C-1 and 32C-2 are second side views of the rear stacker assembly components 280, 282 in FIGS. 32A-1 and 32A-2, respectively, that are configured to be assembled together to form an alternative assembled rear stacker assembly that can be installed in a stackable shelf to support fiber optic equipment. FIGS. 32D-1 and 32D-2 are top views of the stacker assembly components 280, 282 in FIGS. 32A-1 and 32A-2, respectively, that are configured to be assembled together to form an alternative assembled rear stacker assembly that can be installed in a stackable shelf to support fiber optic equipment. FIGS. 32E-1 and 32E-2 are third side views of the rear stacker assembly components 280, 282 in FIGS. 32A-1 and 32A-2, respectively, that are configured to be assembled together to form an alternative assembled rear stacker assembly that can be installed in a stackable shelf to support fiber optic equipment. FIGS. 32F-1 and 32F-2 are bottom views of the rear stacker assembly components 280, 282 in FIGS. 32A-1 and 32A-2, respectively, that are configured to be assembled together to form an alternative assembled rear stacker assembly that can be installed in a stackable shelf to support fiber optic equipment.

Many modifications and other embodiments of the invention set forth herein will come to mind to one skilled in the art to which the invention pertains having the benefit of the teachings presented in the foregoing descriptions and the associated drawings. As discussed herein, a stacker assembly is any component, member, or assembly that is configurable to support fiber optic equipment at a different desired height or heights (e.g., U spaces) from a surface, including but not limited to the mounting surface 20 provided for the stackable shelves 10, 10′ disclosed and discussed herein. As non-limiting examples set forth below, the stackable shelves disclosed herein can includes features which allow components to stack on it. These features could be holes, slots, or other geometries which allow other components to attach to the stackable shelf by snapping or sliding into place. Front stacker assemblies can serve several purposes. One is to provide the front stacker assemblies as one of the potential building blocks that allow for conversion among rack spacings. The stacker assemblies can also contain features to retain fiber optic panels, fiber optic modules, cassettes, or other pieces of equipment. Connectors, splices, splitters, and other components may be held in place by the front stacker assemblies and/or the rear stacker assemblies.

The rear stacker assembly can assist in extending the support structure in the depth of the housing dimension. For instance, if the piece of equipment to be installed in the housing takes up a significant amount of the depth of the housing, it may require support throughout its length. By breaking up the stacking components into a front stacker assembly and a rear stacker assembly, the flexibility to accommodate more potential installation situations and configurations can be increased without dramatically increasing the complexity of the housing. The front routing guide can be provided to attach to both the stackable shelf and the front stacker assembly.

The removable panel clip, front stacker assembly, and rear stacker assembly may be removably attached to the stackable shelves to allow the stackable shelves to accommodate both fiber optic modules, cassettes and fiber optic panels, either together or separately, and whether or not the fiber optic modules, cassettes or fiber optic panels employ plungers or a track-type system as their method of retention in and to the stackable shelf. In this regard, the fiber optic housings in which the stackable shelf movably mounts can be compatible for either or both fiber optic modules, cassettes and/or fiber optic panels. Further, the fiber optic modules, cassettes and fiber optic panels may be interchangeable on the stackable shelf and, therefore, within the fiber optic housing. The stackable shelves, the removable panel clips, the front stacker assemblies, and the rear stacker assemblies may be constructed to snap together to easily facilitate initial configuration or subsequent reconfiguration of the stackable shelves.

The removable panel clips can serve as an adapter piece which allows plunger-style panels to be used where a track-type method of retention is used. The removable panel clips can contains protrusions on the exterior that snap into a raised portion of the stackable shelf and slide over the track feature. The front stacker assembly pieces and rear stacker assembly pieces can be composed of two (2) wedge-shaped pieces which snap together and in turn contain features which allow them to attach to the mounting surface of the stackable shelf. The front stacker assemblies may be shorter than the rear stacker assemblies. The stacker assemblies may allow a track-type module to be used in a housing that accommodates plunger-style panels. The removable panel clips can be used alone or in combination with the front stacker assembly and/or rear stacker assembly depending on the desired configuration. The material of construction may be metal or non-metal as examples. The removable panel clips could also be reversed one hundred eighty (180) degrees from the orientations discussed and illustrated above to allow the fiber optic panel position disposed therein to move independently, allowing the use of attenuators and/or other fiber optic devices, if desired.

The routing guides may be configured to rotatably attach to a mounting surface, such as, for example, a stackable shelf using an attachment feature. The attachment feature may have a pattern of specifically shaped holes in the surface of the stackable shelf that allows the routing guide to lock in place at various angles. The pattern of holes on the stackable shelf, or other mounting surface, can include an access hole and a plurality of locater holes. The base of the routing guide can be inserted into the access hole. The routing guide can lock into place by turning the routing guide counterclockwise as an example. A sloped profile of the base in combination with a “tooth” protruding from the base of the routing guide can be configured to snap into one of several locator holes allowing the routing guide to releasably lock into place at that angular position.

The placement of the access hole and locator holes in the mounting surface may resemble a “paw print” shape. The access hole can be shaped such that the routing guide can only be inserted in one particular orientation. The locator holes can be spaced such that after the routing guide has been inserted, it can be rotated counterclockwise allowing the protrusion or “tooth” on the routing guide base to interact with the holes to effectively lock it into an angled position. The holes can be situated on the centerline of the path of the tooth of the routing guide as it is rotated to provide multiple locking positions as desired. In this manner, the protrusion is movably positionable into different ones of the locater holes.

The base of the routing guides can have a spherical protrusion that engages the locator holes in the mounting surface. The spherical shape allows the guide to releasably lock in position, but also allows for movement and adjustability in either direction if additional force is applied. The profile of the base is sloped so that constant tension is maintained between the underside of the mounting surface and the base. The routing guide may be provided as segments. In this regard, the routing guide may have diagonal posts on the interior of the upper portion. These posts provide different segments in the upper portion allowing for the segregation or separation of fiber types or bundles. For instance, if the user intends to store slack for both buffer tubes and 250 micrometers (μm) fiber, one type can be stored in the interior of the posts while the other can be stored underneath the posts inside the routing guide.

The routing guide may be constructed of metal or non-metal material as examples. Additionally, the shape of the routing guide could be a different shape than what is shown. Moreover, the footprint of the hole arrangement of the attachment feature could also vary. In addition, the features could be reversed—the hole could be on the routing guide and the tooth protrusion could be on the mounting surface.

Further, as used herein, it is intended that terms “fiber optic cables” and/or “optical fibers” include all types of single mode and multi-mode light waveguides, including one or more optical fibers that may be bare, upcoated, colored, buffered, tight-buffered, loose-tube, ribbonized and/or have other organizing or protective structure in a cable such as one or more tubes, strength members, jackets or the like. Likewise, other types of suitable optical fibers include bend-insensitive optical fibers, or any other expedient of a medium for transmitting light signals. An example of a bend-insensitive, or bend resistant, optical fiber is ClearCurve® Multimode fiber commercially available from Corning Incorporated. Suitable fibers of this type are disclosed, for example, in U.S. Patent Application Publication Nos. 2008/0166094 and 2009/0169163.

Therefore, it is to be understood that the embodiments are not to be limited to the specific embodiments disclosed and that modifications and other embodiments are intended to be included within the scope of the appended claims. It is intended that the embodiments cover the modifications and variations of this invention provided they come within the scope of the appended claims and their equivalents. Although specific terms are employed herein, they are used in a generic and descriptive sense only and not for purposes of limitation.

What is claimed is:

1. A stackable shelf for a fiber optic housing, comprising:
a mounting surface; and
one or more stacker assemblies stacked above the mounting surface, each configured to support fiber optic equipment in one or more height spaces;
wherein the one or more stacker assemblies are further configured to support one or more additional removable stacker assemblies each configured to support fiber optic equipment at one or more additional height spaces.

2. The stackable shelf of claim 1, wherein the one or more stacker assemblies are each configured to support the fiber optic equipment in a 1-U or greater space.

3. The stackable shelf of claim 1, further comprising the one or more additional removable stacker assemblies stacked above the one or more stacker assemblies.

4. The stackable shelf of claim 3, wherein each of the one or more additional removable stacker assemblies is configured to support the fiber optic equipment in a 1 U or greater space.

5. The stackable shelf of claim 1, wherein the one or more stacker assemblies are comprised of one or more removable stacker assemblies.

6. The stackable shelf of claim 5, further comprising a latch disposed in a bottom of each of the one or more removable stacker assemblies configured to be inserted into a receiver disposed in the stackable shelf.

7. The stackable shelf of claim 5, further comprising a latch disposed in a bottom of each of the one or more removable stacker assemblies configured to be inserted into a receiver disposed in a top of another removable stacker assembly among the one or more removable stacker assemblies.

8. The stackable shelf of claim 1, further comprising a receiver disposed in a top of each of the one or more stacker assemblies configured to receive a latch disposed in a bottom of another removable stacker assembly among the one or more removable stacker assemblies.

9. The stackable shelf of claim 1, further comprising a fiber routing guide attached to at least one of the one or more stacker assemblies.

10. The stackable shelf of claim 1, wherein the one or more stacker assemblies are each configured to support at least one of a fiber optic module and a fiber optic panel.

11. The stackable shelf of claim 1, further comprising a second one or more stacker assemblies disposed adjacent to the one or more stacker assemblies configured to support the fiber optic equipment between the one or more stacker assemblies and the second one or more stacker assemblies.

12. The stackable shelf of claim 1, further comprising at least one stackable fiber body holder attached to the stackable shelf configured to support one or more fiber body holders.

13. The stackable shelf of claim 12, further comprising an additional fiber body holder stacked on the stackable fiber body holder configured to support one or more additional fiber body holders.

14. The stackable shelf of claim 1, further comprising at least one removable fiber routing guide attached to the stackable shelf configured to route optical fibers in the stackable shelf.

15. The stackable shelf of claim 1, wherein the one or more stacker assemblies are comprised of one or more front stacker assemblies.

16. The stackable shelf of claim 15, wherein each of the one or more front stacker assemblies is configured to receive at least one removable panel clip configured to support a fiber optic panel.

17. The stackable shelf of claim 16, further comprising at least one opening disposed in each of the one or more front stacker assemblies and each configured to receive a flange disposed in the at least one removable panel clip.

18. The stackable shelf of claim 17, wherein the at least one opening is comprised of a first opening disposed on a first side in each of the one or more front stacker assemblies and a second opening disposed on a second side in each of the one or more front stacker assemblies opposite of the first side, each of the first opening and the second opening configured to receive the flange disposed in the removable panel clip.

19. The stackable shelf of claim 17, wherein the flange is configured to be inserted in a first area of the at least one opening and slid into a second area of the at least one opening.

20. The stackable shelf of claim 17, wherein the at least one opening is configured to receive a protrusion disposed in the at least one removable panel clip.

21. The stackable shelf of claim 1, wherein the one or more stacker assemblies are comprised of one or more rear stacker assemblies.

22. The stackable shelf of claim 21, further comprising at least one rail disposed in each of the one or more rear stacker assemblies configured to receive at least one rail guide disposed in the fiber optic equipment to support the fiber optic equipment.

23. The stackable shelf of claim 22, wherein the one or more rear stacker assemblies are comprised of one or more rear removable stacker assemblies.

24. The stackable shelf of claim 23, further comprising at least two latches disposed in a bottom of each of the one or more rear removable stacker assemblies configured to be inserted into at least two receivers disposed in the stackable shelf.

25. The stackable shelf of claim 23, further comprising at least two latches disposed in a bottom of each of the one or more rear removable stacker assemblies configured to be inserted into at least two receivers disposed in a top of another rear removable stacker assembly among the one or more rear removable stacker assemblies.

26. The stackable shelf of claim 23, further comprising at least two receivers disposed in a top of each of the one or more rear removable stacker assemblies configured to receive at least two latches disposed in a bottom of another rear removable stacker assembly among the one or more rear removable stacker assemblies.

27. A method for installing fiber optic equipment in a stackable shelf, comprising:
providing a mounting surface;
stacking one or more stacker assemblies above the mounting surface, each of the one or more stacker assemblies configured to support the fiber optic equipment in one or more height spaces; and
installing the fiber optic equipment supported by the one more stacker assemblies stacked about the mounting surface.

28. The method of claim 27, further comprising installing the stackable shelf supporting the fiber optic equipment into a fiber optic housing.

29. The method of claim 27, wherein the one or more stacker assemblies are comprised of one or more removable stacker assemblies.

30. The method of claim 29, further comprising inserting a latch disposed in a bottom of each of the one or more removable stacker assemblies into a receiver disposed in the stackable shelf.

31. The method of claim 29, further comprising inserting a latch disposed in a bottom of each of the one or more removable stacker assemblies into a receiver disposed in a top of another removable stacker assembly among the one or more removable stacker assemblies.

32. The method of claim 29, further comprising receiving in a receiver disposed in a top of each of the one or more removable stacker assemblies a latch disposed in a bottom of another removable stacker assembly among the one or more removable stacker assemblies.

33. The method of claim 27, further comprising attaching a fiber routing guide to at least one of the one or more stacker assemblies.

34. The method of claim 27, wherein installing the fiber optic equipment comprises installing at least one of a fiber optic module and a fiber optic panel supported by the one more stacker assemblies.

35. The method of claim 27, further comprising installing a second one or more stacker assemblies disposed adjacent to the one or more stacker assemblies configured to support fiber optic equipment between the one or more stacker assemblies and the second one or more stacker assemblies.

36. The method of claim 27, wherein stacking the one or more stacker assemblies comprises stacking one or more front stacker assemblies above the stackable shelf, each of the one or more front stacker assemblies configured to support fiber optic equipment in one or more height spaces.

37. The method of claim 36, further comprising attaching at least one removable panel clip configured to support a fiber optic panel to the one or more front stacker assemblies.

38. The method of claim 27, wherein stacking the one or more stacker assemblies comprises stacking one or more rear stacker assemblies above the stackable shelf, each of the one or more rear stacker assemblies configured to support fiber optic equipment in one or more height spaces.

39. The method of claim 38, further comprising disposing at least one rail disposed in each of the one or more rear stacker assemblies in at least one rail guide disposed in the fiber optic equipment.

40. The method of claim 39, wherein the one or more rear stacker assemblies are comprised of one or more rear removable stacker assemblies.

41. The method of claim 40, further comprising inserting at least two latches disposed in a bottom of each of the one or more rear removable stacker assemblies into at least two receivers disposed in the stackable shelf.

42. The method of claim 40, further comprising inserting at least two latches in a bottom of each of the one or more rear removable stacker assemblies into at least two receivers disposed in a top of another rear removable stacker assembly among the one or more rear removable stacker assemblies.

43. The method of claim 40, further comprising inserting at least two receivers disposed in a top of each of the one or more rear removable stacker assemblies into at least two latches disposed in a bottom of another rear removable stacker assembly among the one or more rear removable stacker assemblies.

44. A removable stacker assembly configured to support fiber optic equipment in a stackable shelf, comprising:
a support member, comprising:
a support body;
at least one receiver disposed in the support body and configured to support the fiber optic equipment in the stackable shelf in a height space; and
at least one second receiver disposed in the support body and configured to support one or more additional removable stacker assemblies each configured to support fiber optic equipment at one or more additional height spaces; and
an attachment member configured to receive the support member and comprising:
an attachment body; and
at least one latch disposed in the attachment body and configured to be attached to at least one receiver in the stackable shelf to secure the attachment member receiving the support member to the stackable shelf.

45. The removable stacker assembly of claim 44, wherein the at least one receiver is comprised of at least one opening.

46. The removable stacker assembly of claim 44, wherein the at least one second receiver is comprised of at least one second opening.

47. The removable stacker assembly of claim 46, wherein the at least one second opening is comprised of at least one keyed portion.

48. The removable stacker assembly of claim 44, further comprising at least one second latch disposed in the attachment body and receiving at least one third receiver disposed in the support body for the attachment member to receive the support member.

49. The removable stacker assembly of claim 45, wherein the at least one opening disposed in the support body is comprised of a first opening disposed on a first side of the support body and a second opening disposed on a second side of the support body opposite of the first side.

50. The removable stacker assembly of claim 49, wherein each of the first opening and the second opening disposed in the support body are configured to receive a flange disposed in a removable panel clip to support a fiber optic panel.

51. The removable stacker assembly of claim 50, wherein the at least one opening disposed in the support body is configured to initially receive the flange in a first area of the at least one opening disposed in the support body and the flange when slid into a second area of the at least one opening disposed in the support body.

52. The removable stacker assembly of claim 49, wherein the at least one opening disposed in the support body is configured to receive a protrusion disposed in a removable panel clip.

53. The removable stacker assembly of claim 44, further comprising at least one fiber routing guide receiver disposed in the support body and configured to receive a fiber routing guide.

54. The removable stacker assembly of claim 44, wherein the at least one receiver is comprised of two or more openings.

55. The removable stacker assembly of claim 44, wherein the at least one second receiver is comprised two or more second openings.

56. The removable stacker assembly of claim 55, wherein the two or more second openings are comprised of two or more keyed portions.

57. The removable stacker assembly of claim 44, further comprising two or more second latches disposed in the attachment body and receiving two or more third receivers disposed in the support body for the attachment member to receive the support member.

58. The removable stacker assembly of claim 44, further comprising a rail guide disposed in fiber optic equipment configured to receive at least one rail disposed in the support member to support the fiber optic equipment.
